(19) United States
(12) Patent Application Publication
(10) Pub. No.: US 2011/0298805 A1
(43) Pub. Date: Dec. 8, 2011

(54) Method and Data Processing System for Financial Planning

(75) Inventors: Joshua Laurito, New York, NY (US); Timothy J. Stevens, Stamford, CT (US); Gregg L. Bienstock, Larchmont, NY (US)

(73) Assignee: Lumesis LLC

(21) Appl. No.: 13/046,405

(22) Filed: Mar. 11, 2011

Related U.S. Application Data
(60) Provisional application No. 61/313,105, filed on Mar. 11, 2010.
(60) Provisional application No. 61/314,559, filed on Mar. 16, 2010.

(51) Int. Cl. G06T 11/20; G06Q 40/00

(52) U.S. Cl. 345/440; 705/36 R

(57) ABSTRACT

A computer-implemented method and system for producing a graphic image representative of a certain geographic region indicating certain datasets. The method including selecting at least one objective dataset correlating to the certain geographic region and segmenting the selected at least one objective dataset into a plurality of interval ranges based upon prescribed values. At least one financial dataset is selected representing financial assets relating to the certain geographic region. A graphic image is generated of the certain geographic region indicating the selected objective dataset in accordance with the segmentation of the objective dataset into a plurality of interval ranges with the at least one financial dataset being superimposed on the objective dataset wherein risk exposure of the financial dataset to the certain geographic regions is graphically illustrated on the generated graphic image.

### FIELD OF THE INVENTION

The invention relates to a computer implemented method and data processing system for analyzing demographic, economic, financial and political data relating to financial assets, and more specifically, to a computer implemented method and system for providing an informative visualization and analysis of certain financial assets using objective datasets relating to targeted geographic regions and portfolios.

### BACKGROUND OF THE INVENTION

Presently, many software companies have developed and marketed financial analysis software packages. The functionality, prices and target markets of these packages has varied significantly. One commonality of these financial packages is a lack of multi-dimensional financial reporting and in particular the analysis designed to provide meaningful insight to the owner or manager of the analyzed financial assets.

The reporting of financial information typically takes two forms, namely: (1) reports containing figures (single dimensional); and (2) graphic depictions of these figures (dual dimensional). Both forms usually represent a one or two dimensional, static and historical view of one particular segment regarding the subject analyzed financial asset.

Accordingly, there exists a need for a system for visualizing financial data in a more dynamic format providing visual indication of exposure risks and opportunities.

### SUMMARY OF THE INVENTION

In one aspect, a system and method for conducting risk exposure for certain financial assets is described in which an aspect of the invention in accordance with certain illustrated embodiments includes a computer-implemented method for producing a graphic image representative of a certain geographic region indicating certain datasets and the use of analytical and comparison tools to identify areas or positions of interest or concern.

The method preferably includes selecting at least one objective dataset (e.g., unemployment data, crime statistics, education data, housing data and the like) correlating to a geographic area such as all of the States or counties in the Untied States and its territories. This objective dataset is then segmented into a plurality of predetermined interval ranges, either equidistant division, equivalent count or user selected prescribed values. At least one financial portfolio (e.g., municipal bonds, a portfolio of investments, insurance policy par amounts, mortgages, risks values in specific geographic areas and the like) is selected representing financial assets relating to the certain geographic region.

A graphic image is generated of the certain geographic region (e.g., a map of the United States delineated in accordance with the individual counties of each state) illustrating the selected objective dataset in accordance with the segmentation of the objective dataset into a plurality of interval ranges. Then at least one financial portfolio is superimposed by the present invention with the objective dataset such that risk exposure of the financial portfolio relating to the certain geographic regions is graphically illustrated on the generated graphic image. The financial portfolio is represented by a graphic indicator (e.g., circles or stars) and sized proportionately to the relative size of the position to the overall portfolio.

A statistics and comparison chart is generated showing the financial portfolio selected. The user can add to a total of four distinct portfolio sets, allowing for the inclusion of more than one financial portfolio per exposure set. Once selected, the user launches the analysis thereby generating a statistical chart showing general portfolio information, micro-geographic (e.g., State and county level) portfolio concentrations and weighted average measures for as many datasets as the user selects. The concentrations show the user the top ten state or counties and allow them to launch to a graphic view of the same along with information box access and portfolio distribution tables. The weighted average measures can be added to or deleted from and the calculations regenerated automatically.

The user can also select a Search tool that allows them to search for datasets, portfolio information and State and county information by searching for a State, county and/or CUSIP. In each instance, the search result will show all financial portfolios with positions in the searched category and provide the user an information box for further analysis. The user can also identify all financial positions in any selected area and/or financial portfolio.

The user can also use a data filtering tool to identify all geographical areas and related financial positions that share common demographic and economic characteristics based on a user defined set of filtering data parameters. The result set provides a detailed listing of any States, counties and portfolio positions (if applicable) that meet the requirements defined by the user.

### BRIEF DESCRIPTION OF THE DRAWINGS

The objects and features of the invention can be understood with reference to the following detailed description of an illustrative embodiment of the present invention taken together in conjunction with the accompanying drawings in which:

FIG. 1A is a block diagram of a computer system that can be used with certain embodiments of the invention;

FIG. 1B is a flow diagram depicting a process of the present invention according to certain illustrated embodiments;

FIGS. 2-13 depict various computer generated screen shots illustrating the functionality and process of the invention in accordance with certain illustrated embodiments.

### WRITTEN DESCRIPTION OF CERTAIN EMBODIMENTS OF THE INVENTION

The present invention is now described more fully with reference to the accompanying drawings, in which an illustrated embodiment of the invention is shown. The invention is not limited in any way to the illustrated embodiment as the illustrated embodiment described below is merely exemplary of the invention, which can be embodied in various forms, as appreciated by one skilled in the art. Therefore, it is to be understood that any structural and functional details disclosed herein are not to be interpreted as limiting the invention, but rather are provided as a representative embodiment for teaching one skilled in the art one or more ways to implement the invention. Furthermore, the terms and phrases used herein are not intended to be limiting, but rather are to provide an understandable description of the invention. Additionally like reference numerals are to be understood to refer to like elements.

It is to be appreciated that the embodiments of this invention as discussed below may be incorporated as a software algorithm, program or code residing in firmware and/or on computer useable medium (including software modules and browser plug-ins) having control logic for enabling execution on a computer system having a computer processor. Such a computer system typically includes memory storage configured to provide output from execution of the computer algorithm or program.

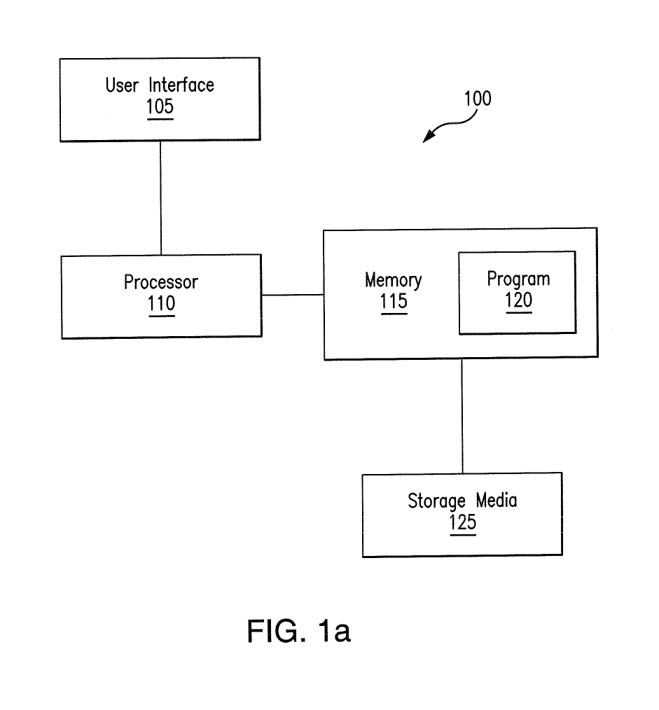

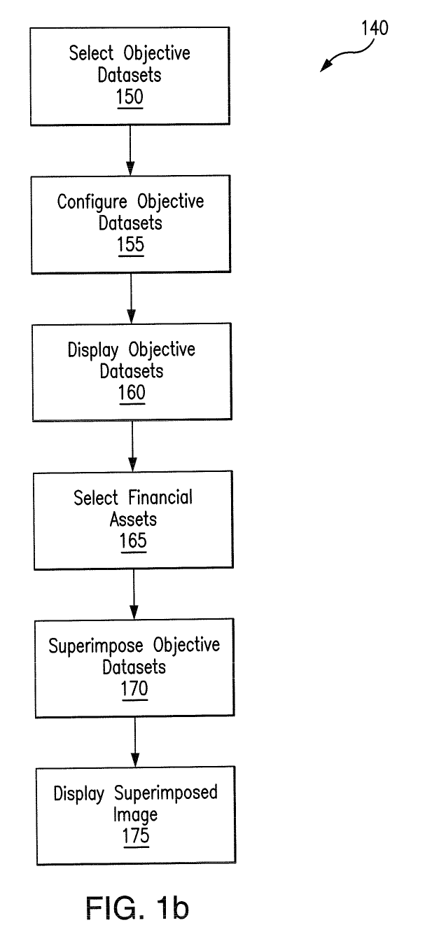

An exemplary computer system is shown as a block diagram in FIG. 1A depicting computer system 100. Although system 100 is represented herein as a standalone system, it is not limited to such, but instead can be coupled to other computer systems via a network (not shown) or encompass other embodiments as mentioned below. System 100 preferably includes a user interface 105, a processor 110 (such as a digital data processor), and a memory 115. Memory 115 is a memory for storing data and instructions suitable for controlling the operation of processor 110.

An implementation of memory 115 can include a random access memory (RAM), a hard drive and a read only memory (ROM), or any of these components. One of the components stored in memory 115 is a program 120.

Program 120 includes instructions for controlling processor 110. Program 120 may be implemented as a single module or as a plurality of modules that operate in cooperation with one another. Program 120 is contemplated as representing a software embodiment of the method 200 described herein below.

User interface 105 can include an input device, such as a keyboard, touch screen, tablet, API web services interface or speech recognition subsystem, for enabling a user to communicate information and command selections to processor 110. User interface 105 also includes an output device such as a display or a printer. In the case of a touch screen, the input and output functions are provided by the same structure. A cursor control such as a mouse, track-ball, or joy stick, allows the user to manipulate a cursor on the display for communicating additional information and command selections to processor 110. In contemplated alternative embodiments of the present invention, the program 120 can execute entirely without user input or other commands based on programmatic or automated access to a data signal flow through other systems that may or may not require a user interface for other reasons.

While program 120 is indicated as already loaded into memory 115, it may be configured on a storage media 125 for subsequent loading into memory 115. Storage media 125 can be any conventional storage media such as a magnetic tape, an optical storage media, a compact disc, a floppy disc, a silicon based memory storage device or the like. Alternatively, storage media 125 can be a random access memory, or other type of electronic storage, located on a remote storage system, such as a server that delivers the program 120 for installation and launch on a user device.

It is to be understood that the invention is not to be limited to such a computer system 100 as depicted in FIG. 1A but rather may be implemented on a general purpose microcomputer incorporating certain components of system 100, such as one of the members of the Sun® Microsystems family of computer systems, one of the members of the IBM® Personal Computer family, one of the members of the Apple® Computer family, or a myriad of other computer processor driven systems, including a: workstations, desktop computers, laptop computers, netbook computers, tablets (e.g., the Apple® IPAD®), a personal digital assistant (PDA), or a smart phone or other like handheld and/or portable devices.

The method 140 described herein has been indicated in connection with a flow diagram depicted in FIG. 1B for facilitating a general description of the principal processes of an illustrated embodiment of the invention; however, certain blocks can be invoked in an arbitrary order, such as when the events drive the program flow such as in an object-oriented program. Accordingly, the flow diagram is to be understood as an example flow and that the blocks can be invoked in a different order than as illustrated.

FIGS. 1A and 1B are intended to provide a brief, general description of an illustrative and/or suitable exemplary environment in which embodiments of the below described present invention may be implemented. FIGS. 1A and 1B are an example of a suitable environment and is not intended to suggest any limitation as to the structure, scope of use, or functionality of an embodiment of the present invention. A particular environment should not be interpreted as having any dependency or requirement relating to any one or combination of components illustrated in an exemplary operating environment. For example, in certain instances, one or more elements of an environment may be deemed not necessary and omitted. In other instances, one or more other elements may be deemed necessary and added.

In the description that follows, certain embodiments may be described with reference to acts and symbolic representations of operations that are performed by one or more computing devices, such as the computing system environment 100 of FIG. 1A. As such, it will be understood that such acts and operations, which are at times referred to as being computer-executed, include the manipulation by the processor of the computer of electrical signals representing data in a structured form. This manipulation transforms the data or maintains them at locations in the memory system of the computer, which reconfigures or otherwise alters the operation of the computer in a manner understood by those skilled in the art. The data structures in which data is maintained are physical locations of the memory that have particular properties defined by the format of the data. However, while an embodiment is being described in the foregoing context, it is not meant to be limiting as those of skill in the art will appreciate that the acts and operations described hereinafter may also be implemented in hardware.

Embodiments may be described in a general context of computer-executable instructions, such as program modules 120, being executed by a computer system 100. Generally, program modules 120 include routines, programs, objects, components, data structures, etc., that perform particular tasks or implement particular abstract data types. An embodiment may also be practiced in a distributed computing environment where tasks are performed by remote processing devices that are linked through a communications network. In a distributed computing environment, program modules 120 may be located in both local and remote computer storage media including memory storage devices.

### Map Data and Portfolios

With the exemplary computing system environment 100 of FIG. 1A being generally shown and discussed above, certain illustrative embodiments of the present invention will now be discussed. The present invention system and process is preferably a software and computer driven application executing on a computer 100 enabling a user to visualize demographic, economic, financial, and political and other user chosen datasets (preferably having a correlation to a financial asset) in integration with data representative of financial assets as chosen by the user (such as municipal bonds) superimposed on a graphic image preferably depicting a geographic region relating to the aforesaid data indicating the user selected financial assets in correlation with the selected user chosen datasets. Datasets are brought in for all users to utilize and, users with an enterprise license, can import their own data for display and use by the user's organization.

As will be appreciated below, the present invention system and process, in accordance with certain illustrated embodiments, provides a user configured interface which displays objective datasets preferably available in a density coded map, such as on a map depicting a geographic region. Therefore, the computer and software generated density coded map functions as a display means for indicating user selected objective or rank ordered datasets in correlation with user selected financial assets and portfolios.

With reference now to FIG. 1B, an illustrative method of operation of the present invention, designated generally by reference numeral 140, will now be described. Starting at step 150, a user preferably selects an objective or rank ordered dataset to be displayed on a graphic image of a geographic region it is representative of. For illustrative purposes, the objective dataset used in the exemplary embodiments of the accompanying figures is unemployment data relating to the month of October 2010 for the United States. It is to be appreciated that the objective dataset is not to be understood to be limited thereto as it may relate to one or more different objective datasets, such as crime, education, housing, income, foreclosure, and other like data having a correlation with a user selected financial assets (e.g., a municipal bond) relating to various geographic regions.

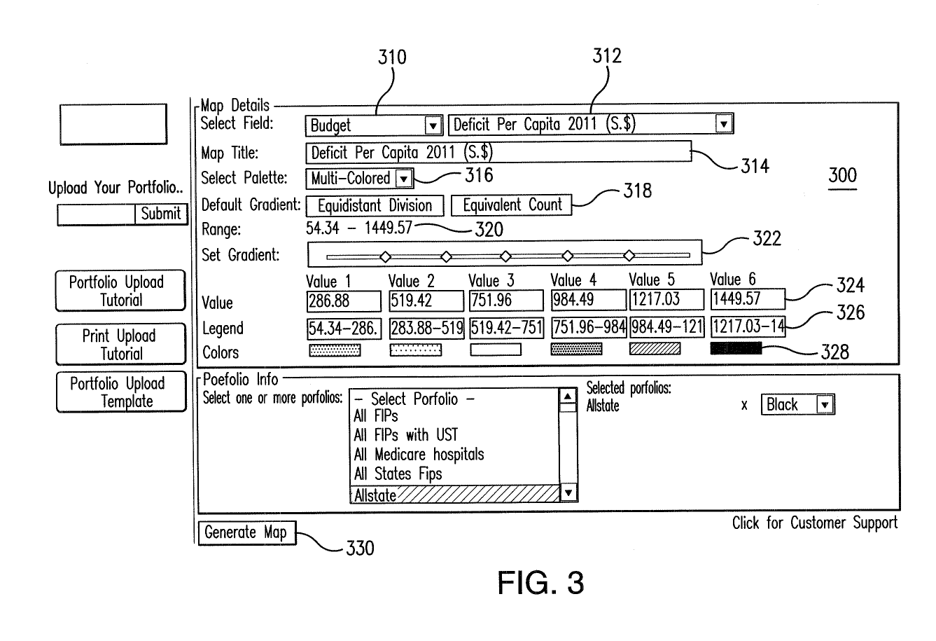

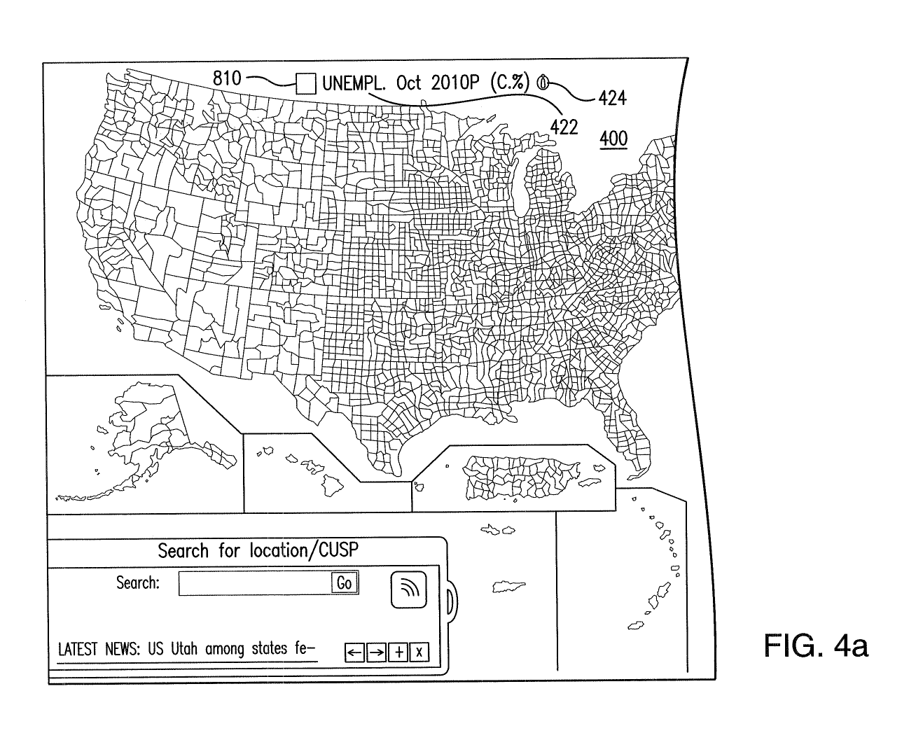

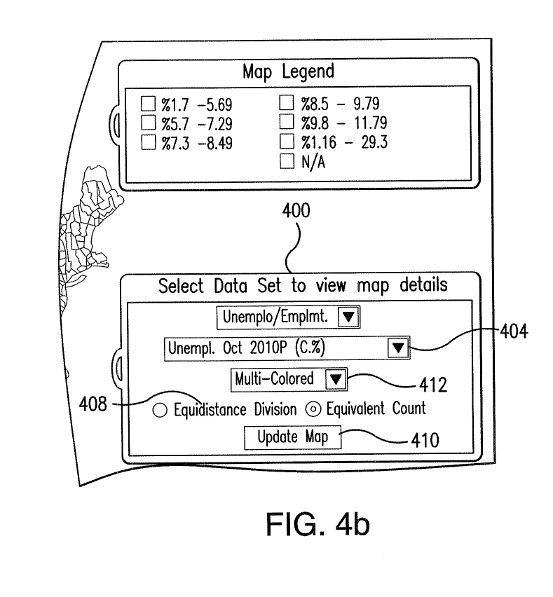

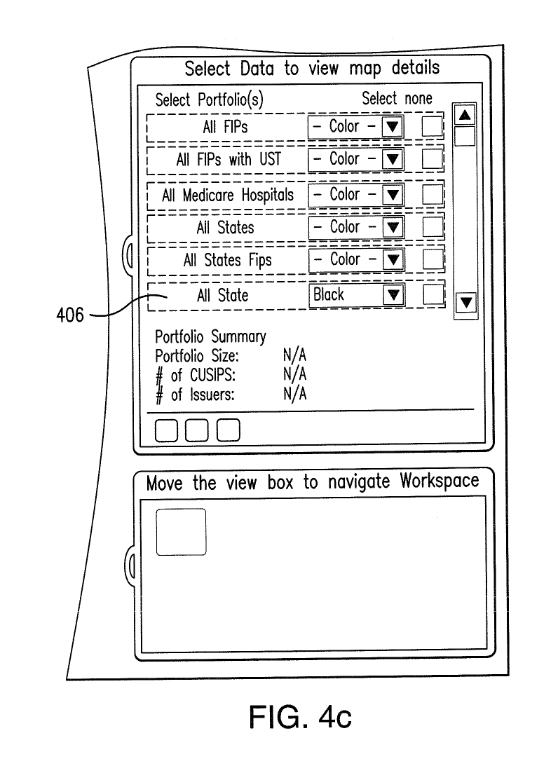

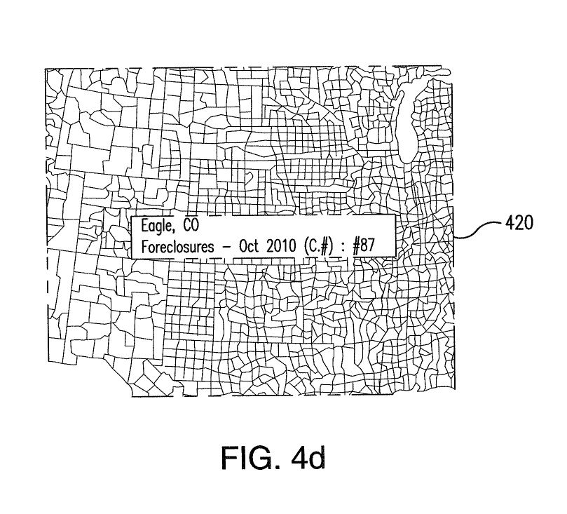

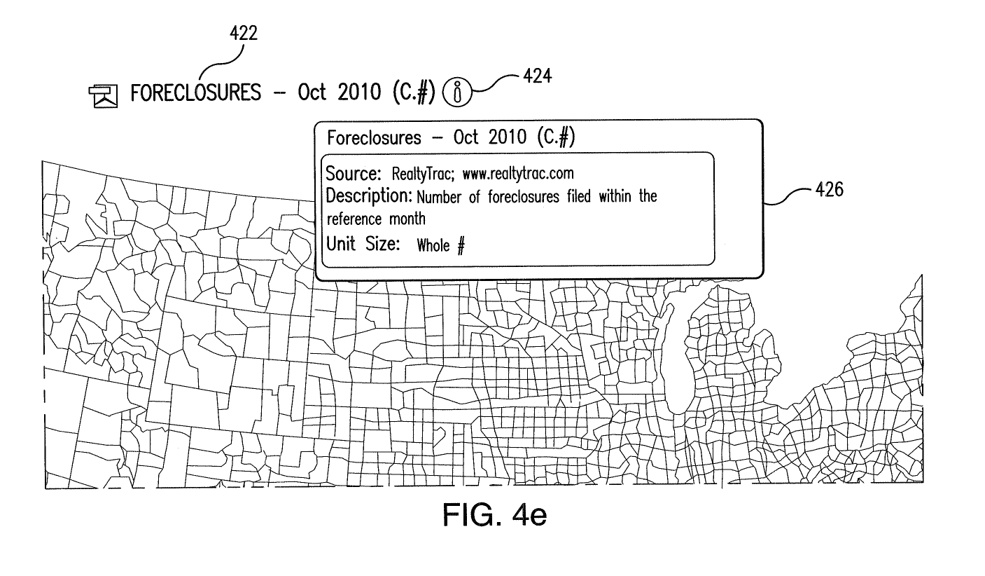

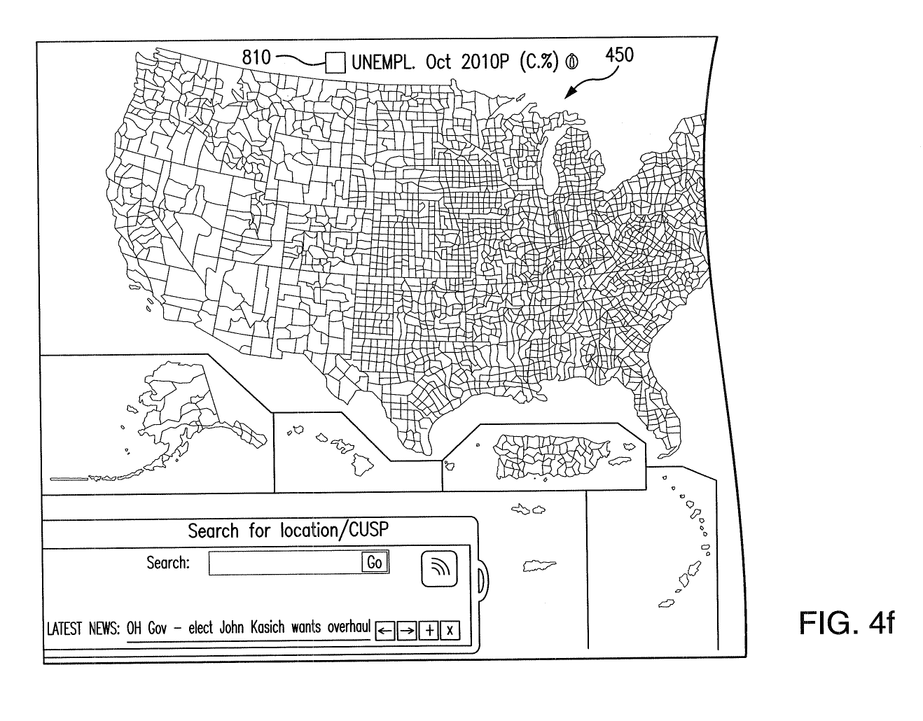

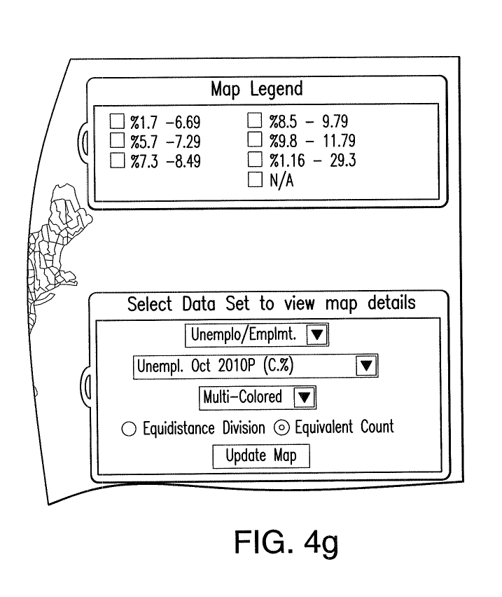

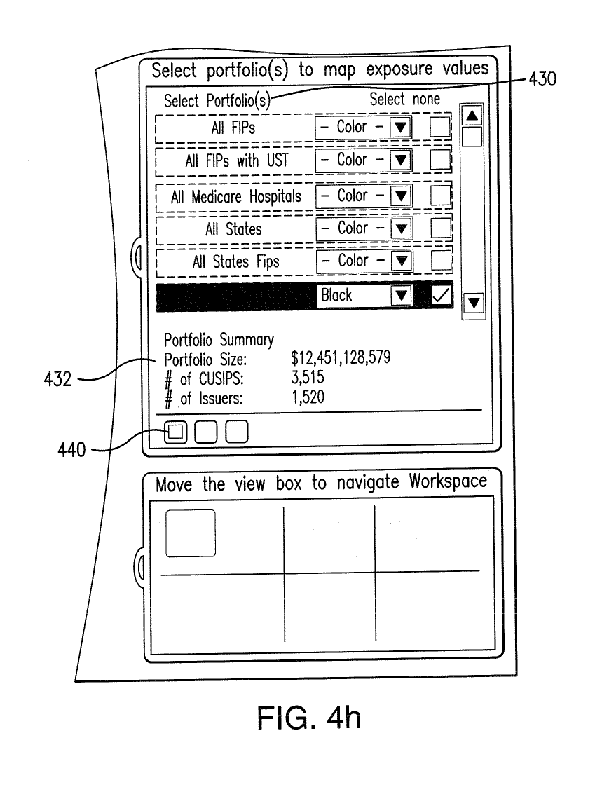

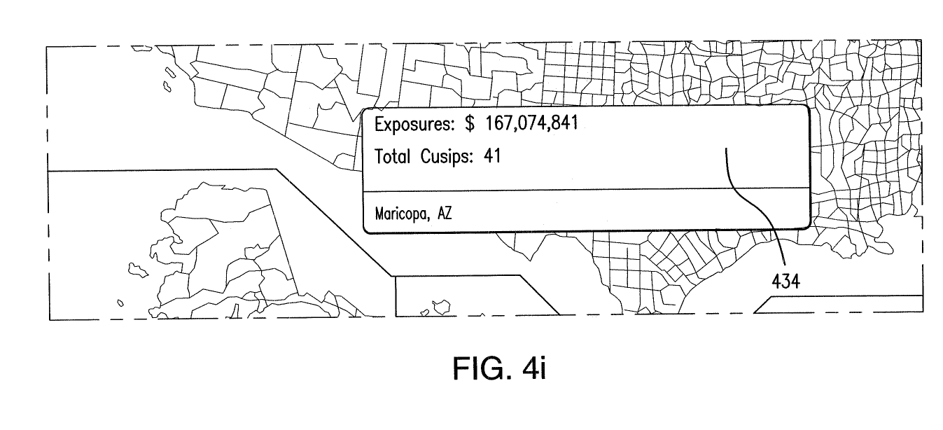

With reference now to FIG. 3 (and with continuing reference to FIG. 1B) the user configures the aforesaid objective dataset for display (step 155). The user is preferably provided with a Graphical User Interface (GUI) 300, preferably via a computer interface 105 (FIG. 1B). A field 310 is provided to select a Data Group and a corresponding field 312 containing objective datasets are presented by system 100 and selected by the user, which are to be used to populate a generated map. A map title or legend is user selected from field 314. For instance, field 312 in FIG. 3, relates to Deficit Per Capita statistics for the United States categorized to each calendar month of a year or multiple years. The below illustrative fields are preferably provided by system 100 in GUI 300 is accordance with a certain illustrated embodiments of the present invention:
Color Palette (316) for selecting a general color for objective datasets to be represented on a generated map (FIG. 4A);
Whether the selected objective datasets are to be represented in Equidistant Division or Equivalent Count (318);
Range parameters for the selected objective datasets (320);
A sliding scale (322) having a plurality (e.g., five (5)) of adjustable nodal points which may be adjusted by the user to prescribe the data intervals for the objective dataset which are to indicated on a generated map (FIG. 4A);
The maximum value (324) for each respective data interval as indicated on the generated map;
The legend (326) to represent each respective data interval as indicated on the generated map (FIG. 4A); and
A color shade (328) to represent each respective data interval as indicated on the generated map (FIG. 4A).

Once these field parameters are selected by a user, the user preferably selects the “Generate Map” icon 330 which instructs program 120 of computer system 100 to generate the map illustrated in FIG. 4A (step 160). It is to be appreciated that the above fields 310-330 described above for depicting an objective dataset on a generated map are for exemplary purposes only and are not to be understood to be limited thereto as numerous fields may be added, deleted or the parameters changed thereof.

With reference now to FIG. 4A, the generated map, designated generally by reference numeral 400, depicts the user selected objective dataset as prescribed per interface 300 described above (FIG. 3). For instance, six dataset intervals are shown representative of unemployment statistics from October 2010 wherein each interval is prescribed per the interval ranges set forth in field 326 and/or via sliding scale 322. All other user selected parameters are depicted in map 400 per the user selected fields of interface 300 (FIG. 3).

With continuing reference to FIGS. 3 and 4a, users can change data groups and datasets. With reference to FIG. 3, a user can change or modify the displayed dataset by following the steps outlined previously (steps 150-160 of FIG. 1B). Thus, upon selecting the “Generate Map” Field 330, an updated map 400 will generate. For instance, a user can change the aforesaid objective dataset for display (step 155). With reference to FIG. 4A, field (402) is provided by system 100 for a user to select a Data Group, and once selected, a field (404) containing objective datasets relating to the user selected Data Group (402) is presented by the system to be user selected which are used to populate the generated map 400. The following other fields are preferably provided in the illustrated GUI of FIG. 4a in accordance with certain illustrated embodiments of the present invention:
Color Palette (412) for selecting spectral color progressions, two color progressions, or a single color progression for objective datasets to be represented on a generated map 400; and
Whether the selected objective datasets are to be represented in Equidistant Division or Equivalent Count (408).

Once these field parameters are user selected, the user preferably selects the “Update Map ” icon (410) which instructs program 120 of computer system 100 to generate the map 400 illustrated in FIG. 4A (step 160). It is to be appreciated the above fields 402-410 described above for depicting an objective dataset on a generated map are for exemplary purposes only and are not to be understood to be limited thereto as numerous fields may be added, deleted or the parameters changed thereof.

With reference to FIGS. 4A and 4B, the system 100 is configured and operative to display State and/or County specific information (FIG. 4b) as selected by the user. This is preferably accomplished by the user hovering his/her mouse device (or other computer coupled pointer device) over a portion of a State or county on map 400 (FIG. 4A) after which the system 100 enlarges that portion of the County and State (FIG. 4B) wherein the county name and user selected dataset are displayed (420). It is to be understood and appreciated, the user can dynamically reset the objective datasets and the data display 420 of FIG. 4B, via the above described GUI 300 of FIG. 3.

It is to be further appreciated that with reference to FIGS. 4A and 4C, when the user hovers it's mouse device (or other computer coupled pointer device) over a portion of a State or county on map 400 (FIG. 4A), the generated map (FIG. 4C) of system 100 is capable of indicating the Source, Description and Unit Size (426) relating to an objective dataset such as “foreclosures” which can be accomplished by the user hovering over the map title (422) or selecting the “i” icon (424) to reveal the Source, Description and Unit Size (426). It is to be understood and appreciated, the user can dynamically update the objective datasets and the data display 400 of FIG. 4, and sub-sequentially display 426 of FIG. 4C, via the above described GUI 300 of FIG. 3.

### Data Upload Process

A further feature of the present invention system and method is the provision of a dynamic user interface configured and operative to accept user data input, such as from a properly formatted Comma Separated Values (CSV) format, Excel file or the like. The present invention system 100 is configured and operative to accept single field data source uploads or multiple data field upload. For certain data sources, the system 100 includes data scrapers configured and operative to enable the system 100 to automatically access identified sources so as to search for and retrieve pre-defined data. Preferably, this pre-defined is imported into system 100 (preferably subjected to quality control process), uploaded to system 100, and then exported for comparison with a data source.

It is to be appreciated data may be imported from public and private sources. It is to be understood an “Original Data” sheet, once the desired data set is identified, the data is captured by system 100 (or an operator thereof) or data scraper and preferably exported to an excel worksheet. Preferably system 100, or an analyst thereof, engages in steps necessary to prepare the data for quality control analysis. This typically involves sorting the data by State and/or county, capturing only relevant data field and performing analysis and calculations as needed. Thus, each “Original Data”, “Formatted Total”, “Calculation”, and the “Generate Calculation Results” cell is engaged and all required calculations are performed to identify changes from the prior period, variances and co-variances. Once the data is verified, all data is preferably tagged with the appropriate Federal Information Processing Standards (FIPS) or American National Standards Institute (ANSI) county or State code. For data sets having multiple data columns, the additional data is preferably input with the corresponding FIPS/ANSI code and data code for system 100 to automatically ingest the properly formatted Excel sheet. It is to be understood FIPS are publicly announced standards developed by the United States federal government for use in computer systems providing a State or county identifier with the corresponding code (S or F). For data sets with multiple data columns, the additional data will be input with the corresponding FIPS and data code for DIVER to automatically ingest the properly formatted Excel sheet. It is also to be appreciated the invention is not to be understood to be limited to using FIPS for specifying a geographic area or location, rather the invention may utilize any means for identifying a geographic region, including, but not limited to: American National Standards Institute (ANSI) and InterNational Committee for Information Technology Standards (INCITS) codes. Thus, reference in herein to FIPS shall also mean and encompass any such standard for specifying a geographic area or location.

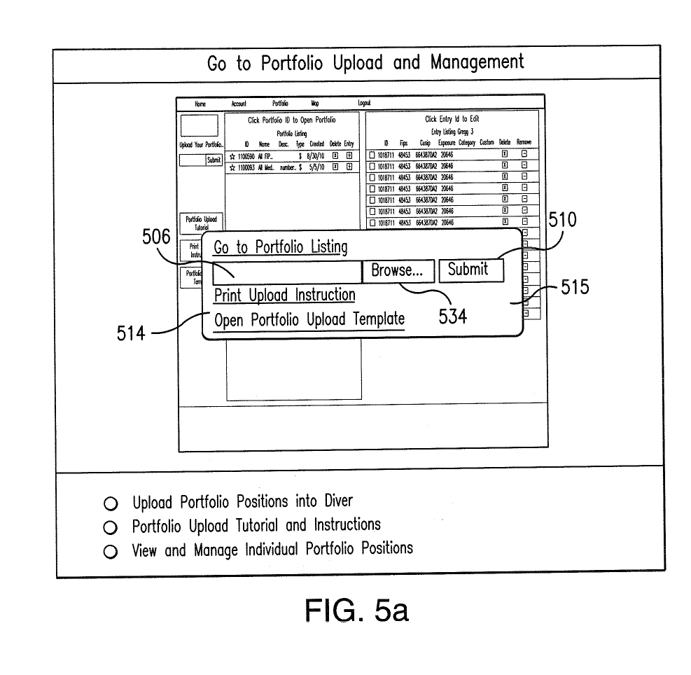

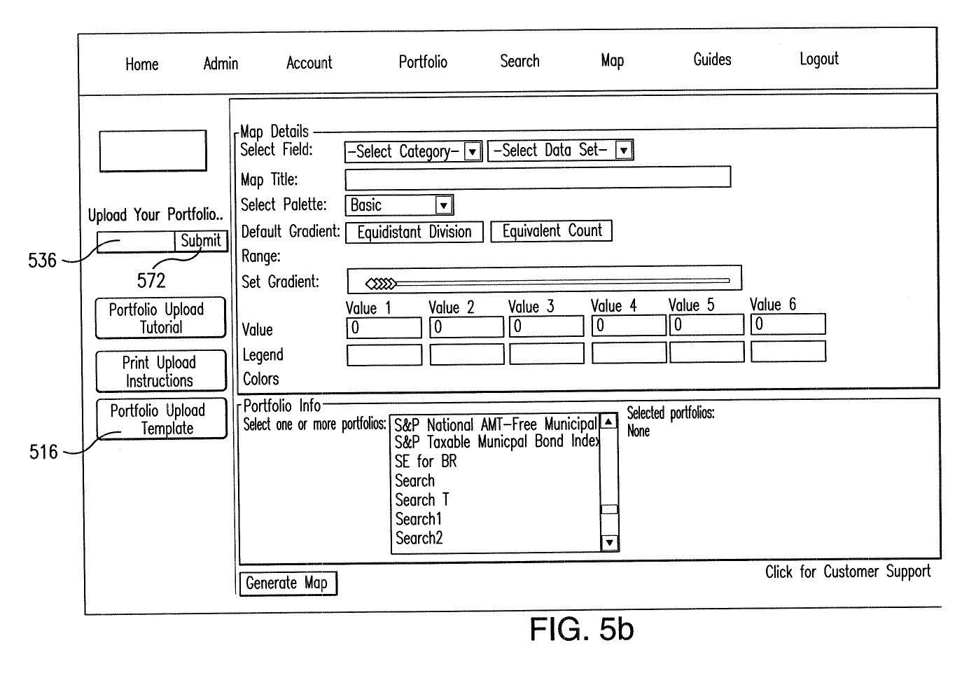

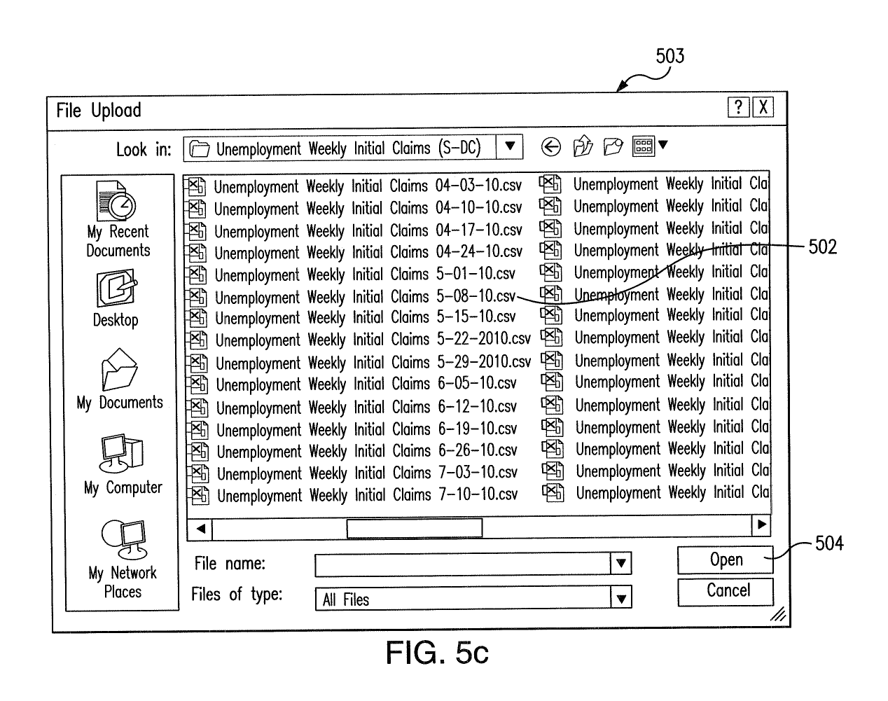

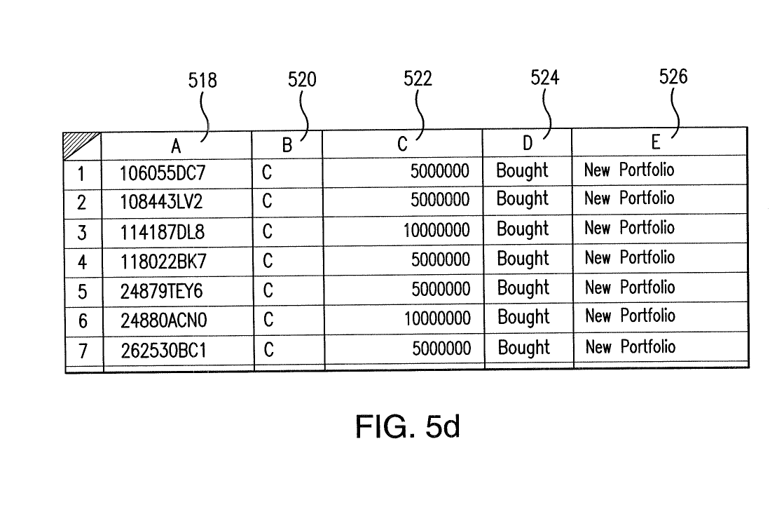

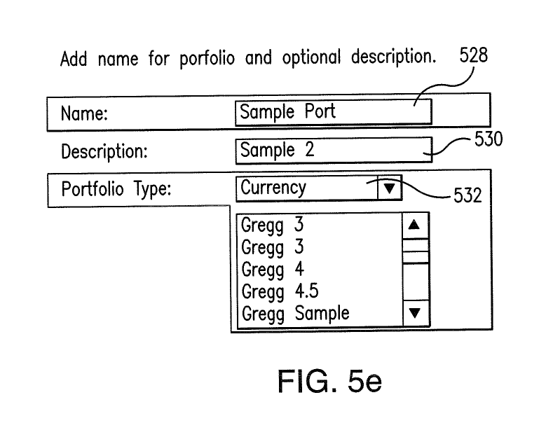

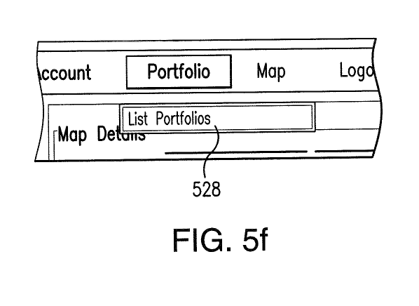

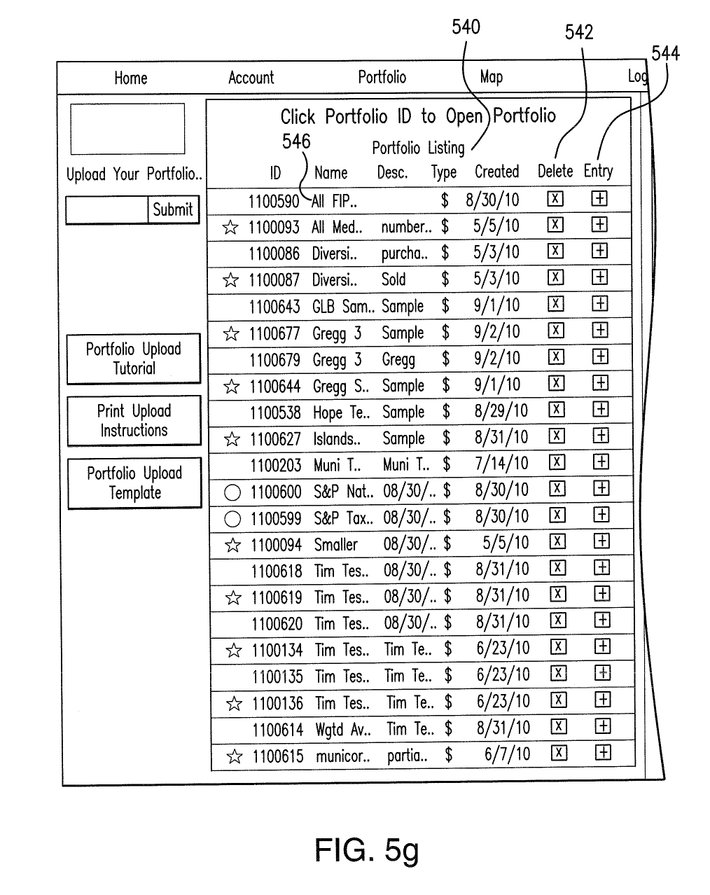

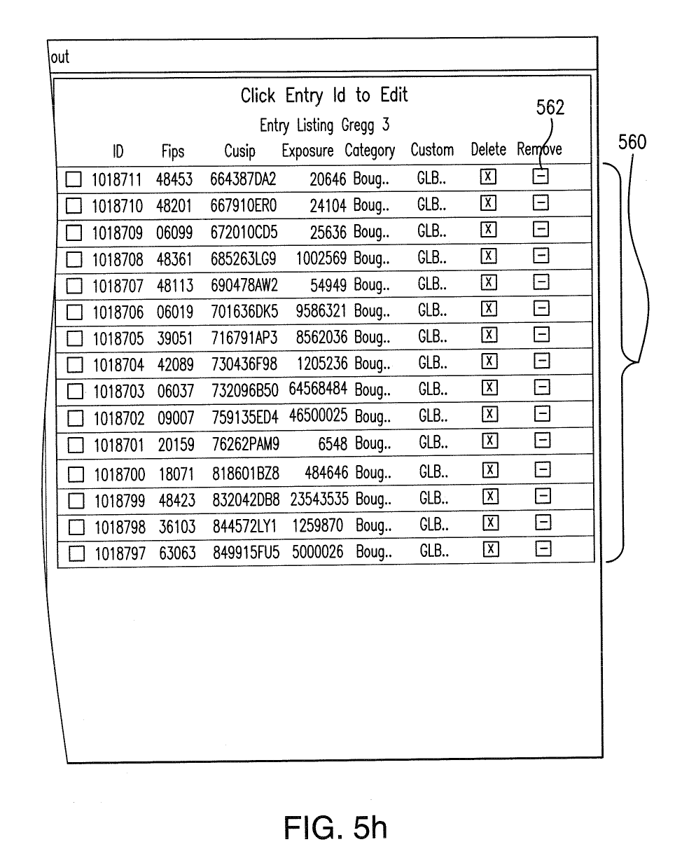

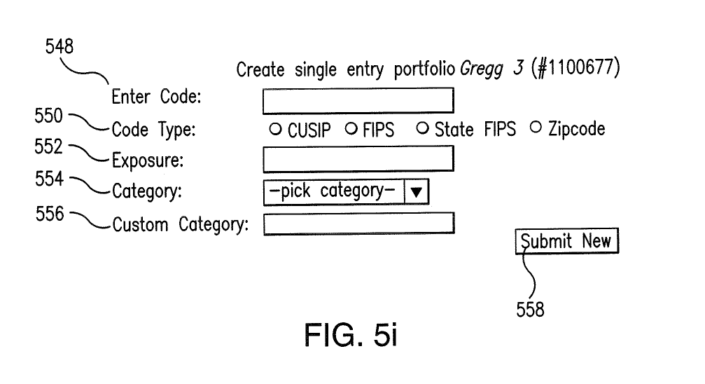

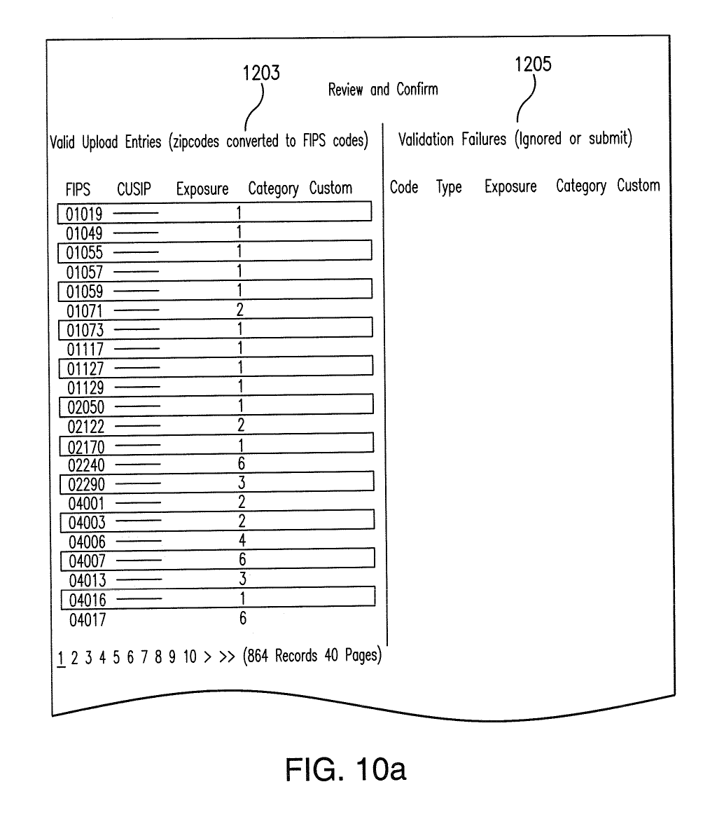

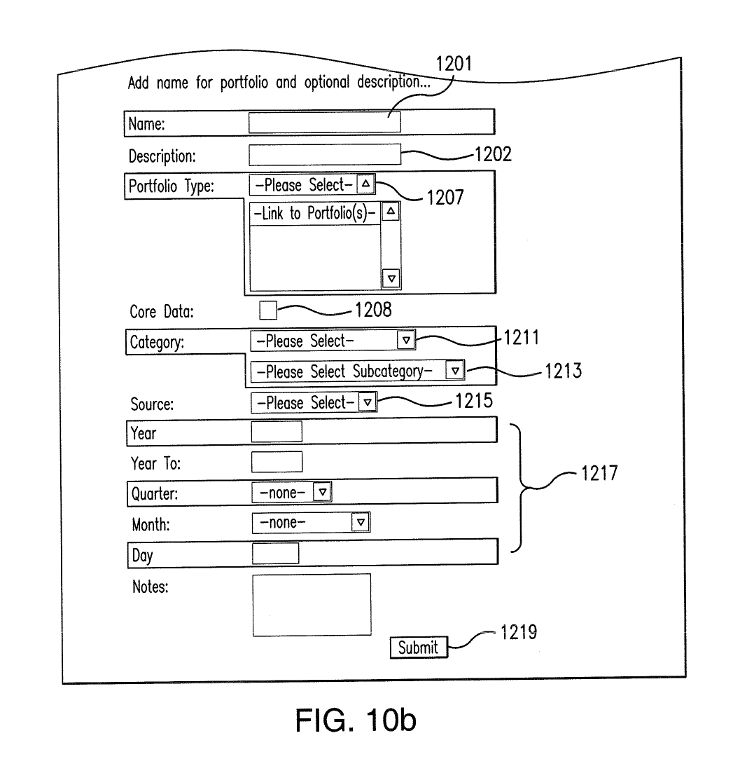

Once the data is properly formatted and saved as a CSV file by system 100, system 100 or an administrator thereof, commences the data upload and tagging process. With reference to FIG. 5a, the administrator selects browse (534) and, with reference to FIG. 5c, identifies the data file (502) for upload and selects “Open” (504). With continuing reference to FIG. 5a, the system 100 administrator selects “submit” (510). With reference now to FIG. 10, upon upload, the system 100 preferably identifies valid uploads (1203) and validation failures (1205).

With continuing reference to FIG. 10, upon successful file import, a system administrator preferably enters the data portfolio name (1201) and description (1202). The administrator then selects core data (1209) so the system 100 allows the administrator to then enter the portfolio type (1207) as preferably either a General Number, Currency or Percentage. The administrator then selects the relevant data Category (1211), sub category (1213) and Source (1215), inputs the relevant date information (1217) and selects “Submit” (1219).

Once uploaded to system 100, and with reference to FIG. 4D, system 100 or an administrator thereof maps the aforesaid uploaded data and preferably uses the CSV export tab (440) to export the data to an excel spreadsheet. The system 100 or an administrator thereof may then compare this data to the original source data to confirm its accuracy. Once validated, the system 100 or an administrator thereof releases the data for user use.

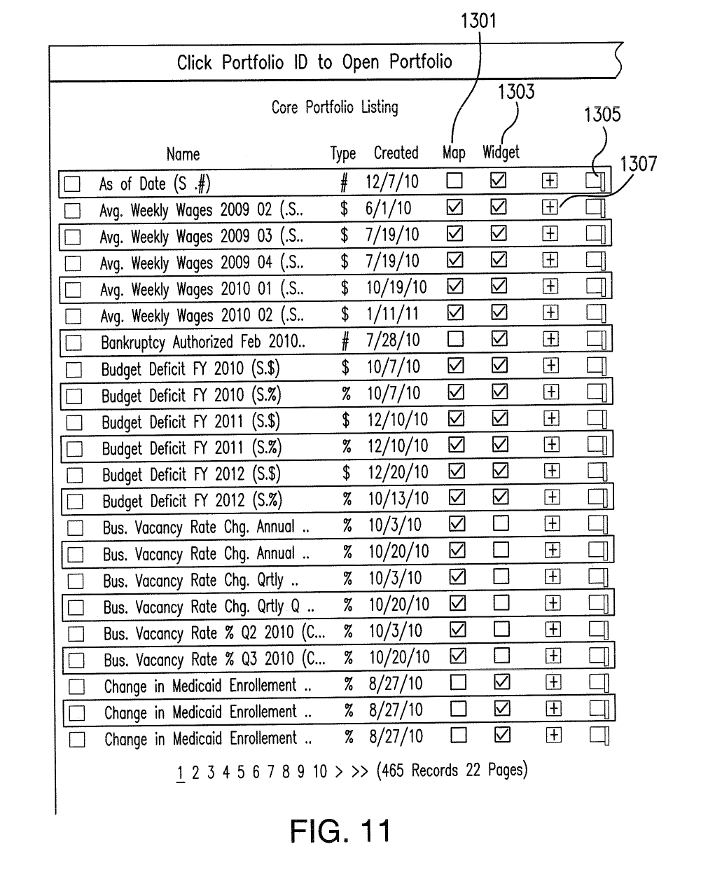

With reference now to FIG. 11, a system administrator can select or deselect the data portfolio for use as either mapped data or as part of an information widget by selecting the corresponding box (1301, 1303). The administrator can also deactivate an uploaded data portfolio (1305) or add additional entries to a data portfolio (1307).

### Portfolio Upload Process

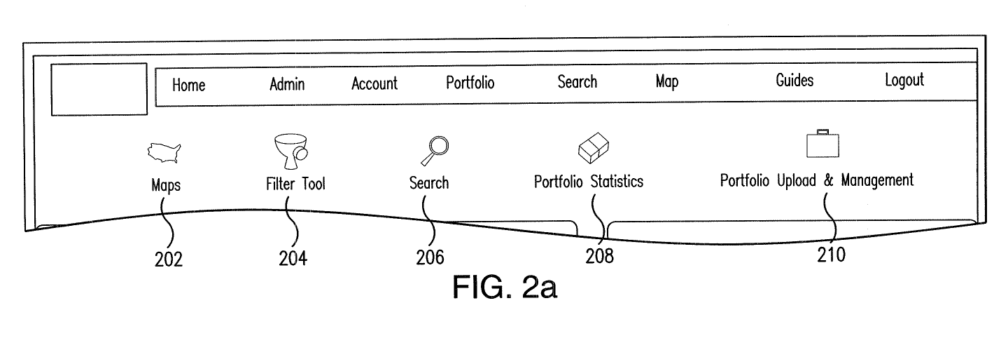

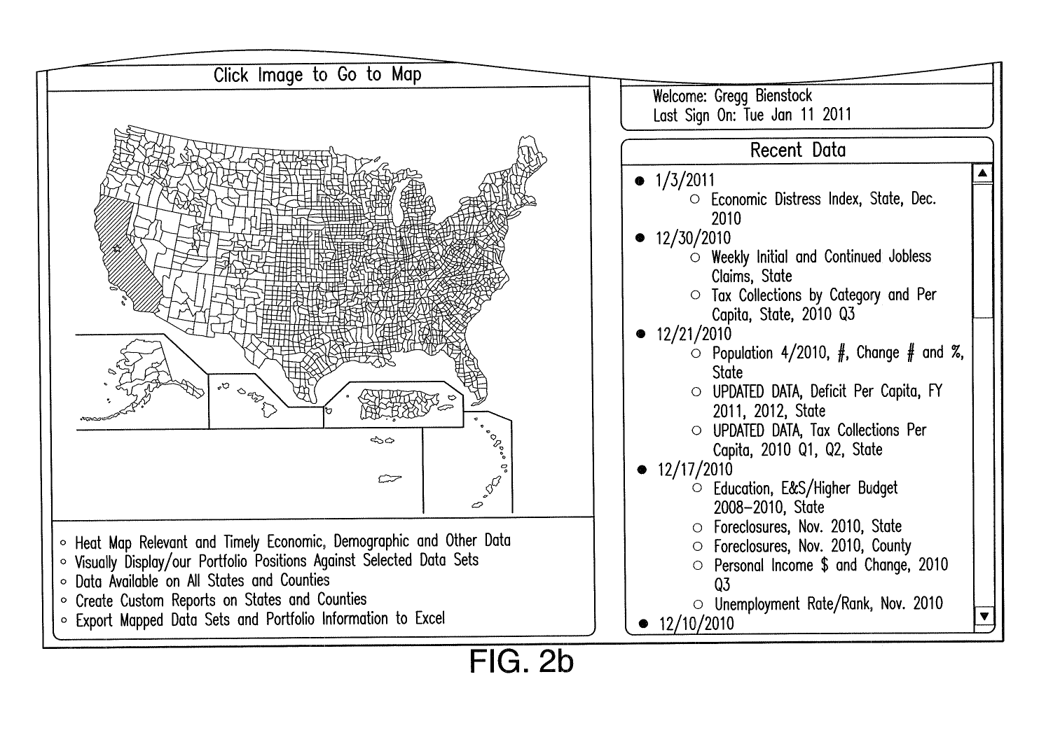

The present invention system 100 and process additionally provides a dynamic interface which accepts user input portfolio data in a plurality of formats including for instance: Committee on Uniform Security Identification Procedures (CUSIP), zip code or FIPS/ANSI code format. Thus, a user portfolio can be loaded or managed for instance using a properly formatted spreadsheet or data file. Thus a user can upload excel files converted to CSV format by providing a CUSIP, zip code or FIPS/ANSI code and an associated value. With reference to FIG. 2, the ability to upload a portfolio can be accessed through either the “Portfolio Upload & Management” tab (210) or the “Map” tab (202). A “Portfolio” may be comprised of any number or types of different assets, liabilities, risks or interests (commercial or otherwise) including but not limited to, securities, loans, receivable interests, real property, inventory, insured exposures, current or contingent liabilities.

Therefore, when a user desires to upload a financial portfolio for correlation with objective datasets as mentioned above, and with reference now to FIGS. 5A and 5B, the user preferably selects “Open Portfolio Template” (514) or “Portfolio Upload Template” (516) so as to open the file, preferably as an Excel file. Once accessed, with reference now to FIG. 5D, the system 100 or an administrator thereof formats the users uploaded portfolio preferably as follows:
Column A (518): Enter the CUSIP, FIPS/ANSI code, State FIPS/ANSI code or Zipcode
   6 or 9 alpha-numeric characters to define a CUSIP
   5 numeric characters to define a county FIPS/ANSI
   2 numeric characters to define a State FIPS/ANSI
   5 numeric characters to define a zip code
Column B (520): Enter the single character description to categorize the code:
   C . . . CUSIP
   F . . . County FIPS
   S . . . State FIPS
   Z . . . Zip Code
Column C (522): Enter the position size (number value only—omit all symbols and decimals and comas)
Column D (524): Categorize the investment(s):
   Potential Buy
   Potential Sell
   Bought
   Sold
   Upgrade
   Downgrade
   Watchlisted
   Illiquid
   Taxable
   Tax-Exempt
   Other
Column E (526): Enter any text, value or leave blank

It is noted after populating the Excel sheet of FIG. 5D, the file is preferably saved on the users PC in CSV format.

With reference now FIG. 5A, when the user hovers its mouse or pointer device over, or clicks on the “Portfolio Upload & Management” link a portfolio upload box 515 appears. With continuing reference to FIG. 5A, the user selects “Browse” (534) or, with reference to FIG. 5B, the dialogue box (536) provided below “Upload Your Portfolio”. Afterwards, and with reference to FIG. 5C, a “File Upload” box (503) will appear. The user then selects their portfolio (502) and with reference to FIGS. 5A and 5B, the user selected portfolio will populate in the space immediately adjacent to the “Browse” (506) and “Upload Your Portfolio” (536). With continued reference to FIGS. 5A and 5B, the user then selects “Submit” (510) (512).

With reference now to FIG. 5E, once the user's portfolio is uploaded to the system 100, the user is prompted to enter a name (528), description (530) and portfolio type (532). The portfolio type (532) can preferably be a number, currency or percentage. And with reference to FIG. 5F, the user can edit or delete exposure sets (portfolio positions) wherein the user accesses the portfolio to update or delete by selecting “List Portfolios” (538). As shown in FIG. 5G, all user portfolios are listed (50) and the user can delete a portfolio (542), add a position (544) or select the portfolio to edit (546). The user can delete a portfolio from the portfolio listing (540) by selecting the delete button (542) for the associated portfolio. The user can add a position to portfolio(s) from the portfolio listing (540) by selecting the entry button (544) for the associated portfolio. With reference to FIG. 5h, the user enters the Code (548), Code Type (550), Exposure (552), Category (554), Custom Category (556) and selects “Submit New” (558). The position is then added to the selected portfolio.

With reference to FIG. 5G, the user can edit a specific user uploaded portfolio. From the portfolio listing (540), the portfolio to be edited is selected (546). The portfolio positions are then preferably displayed (560). The user can delete a position from all portfolios by selecting the delete button (562) for the position. The user can remove a position from a selected portfolio by clicking the “Remove” tab (564).

### Fips/Geo Mapping

It is to be appreciated the system of the invention has mapped all CUSIPs to the appropriate Fips and all issuers to the appropriate State or county. The municipal bonds are assigned to specific political entities such as States, counties, and US territories, protectorates, and subdivisions thereof. Bonds are assigned via a proprietary database created by matching CUSIPs with individual geographical and political entities. This database is constantly reviewed and updated as additional bonds are issued and as political entities are created or consolidated. Data on new bonds is taken weekly via a feed of the CUSIP database and assignment to political entities is done consistent with a set of written procedures aimed at assigning each CUSIP or families of CUSIPs to the political entity most responsible for the repayment of the bond. A user can also override the designated CUSIP mapping for their own use.

### Mapping a Portfolio

With returning reference to FIGS. 3 and 4A, the user selects financial portfolio(s) to be superimposed on the generated map 400 of FIG. 4a (step 165, FIG. 1B). For exemplary purposes and in accordance with the certain illustrated embodiments of the present invention, municipal bond holdings are used as the user financial assets to be superimposed on the generated map 400 wherein each respective bond holding correlates to a geographic region represented on the generated map 400. However, such user financial assets are not to be understood to be limited to such municipal bond holdings as rather they can encompass many other user financial assets having a relationship to a geographic region, such as representing a portfolio of investments, insurance policy par amounts, mortgages, or risks values in specific geographic areas. It is also to be understood that portfolios may relate to non-financial assets, such as the number of hospitals or hospital beds, the number of stores or business locations, the amount of certain agricultural or commodities produced, or other quantifiable attributes of different political divisions or subdivisions. It is also to be appreciated that while the present invention, in accordance with the certain illustrated embodiments, illustrates a single portfolio of user financial assets represented on a generated map 400, it is to be understood that multiple portfolios of user financial assets may be superimposed and integrated with the objective datasets depicted on the generated map 400.

Next, preferably under software control of program 120 of computer system 100, the aforesaid user financial portfolios are properly correlated with and superimposed with the user selected objective datasets (step 170, FIG. 1B). Computer system 100 then generates a map superimposing the user selected objective datasets (FIG. 4) with that of the selected user financial portfolios as shown in FIG. 4D (step 175, FIG. 1B). As shown in FIG. 4D, a user's financial asset holdings are depicted as circular regions or stars (the color of which is selected by the user) (which is not to be understood to be limited thereto) on map 450 wherein the diameter size of each circular region or star is representative of the size of the corresponding asset holding. Different shapes may be assigned to portfolio components that are associated with different types of political divisions to allow further delineation of the different positions that make up the portfolio. As mentioned below, map 450 of FIG. 4D, may then be utilized for analytical purposes to determine a user's risk exposure to certain geographic regions premised upon certain selected objective datasets. Thus, what has been described above in accordance with the certain illustrated embodiments of the present invention is a system and process that calculates six (6) equidistant data ranges, and assigns each of them a color from a user selected color palette, where the intensity of the color is directly related to the data values it represents. The user then preferably selects another dataset composed of personal financial data points (e.g., representing a portfolio of investments, insurance policy par amounts, mortgages, or risks values in specific geographic areas). The present invention system and process is configured and operable to display a representation of the dataset on top of the aforesaid generated base map in the form of colored circles and stars whose diameters are proportional to the positions in the user portfolio of assets.

With continuing reference to FIG. 4D, when a financial portfolio is selected and mapped, the user can select and/or deselect portfolios (430) to map or remove from the map. The user can select the color the financial portfolios will appear on the user defined map (430). As shown, when a financial portfolio is selected and mapped (and when changed, added as multiple or subtracted as fewer portfolios), a portfolio summary box populates (432) with data regarding the portfolio size ($), number of CUSIPs and issuers; the same is dynamically updated as portfolio are selected or de-selected. With reference to FIG. 4E, the user can identify the geographic location and associated portfolio exposure size ($) and number of CUSIPs (434) by hovering over any circle or star.

### Search Tool

With reference now to FIG. 2, the user can select “Search” (206) and the present invention system and process allows the user to select a specific area (State or county) or CUSIP to identify the geographic location and display data and portfolio positions associated with that area or CUSIP.

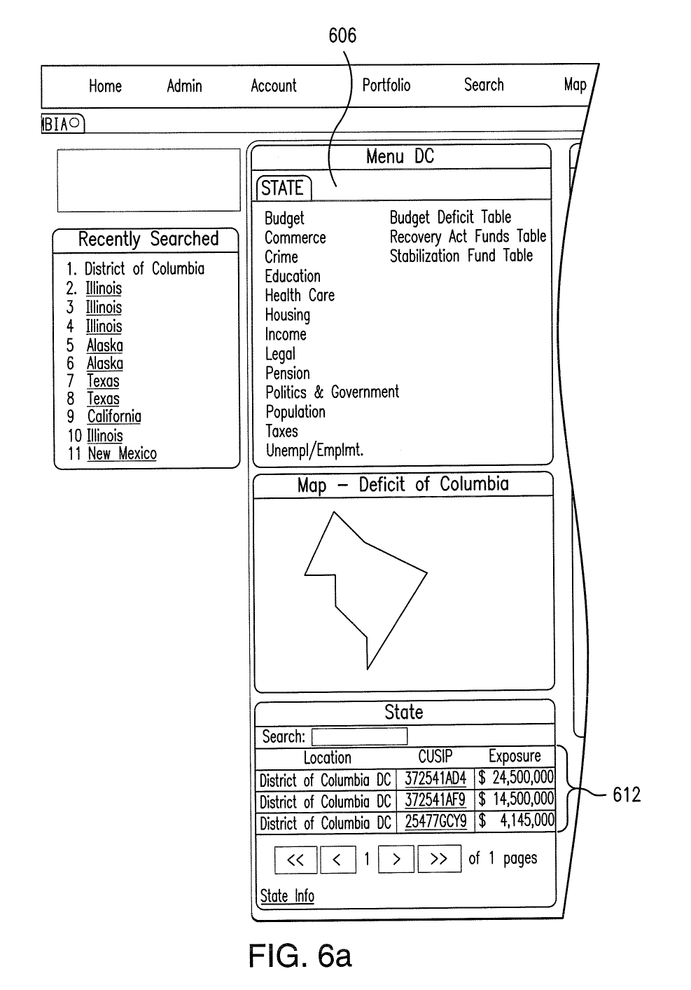

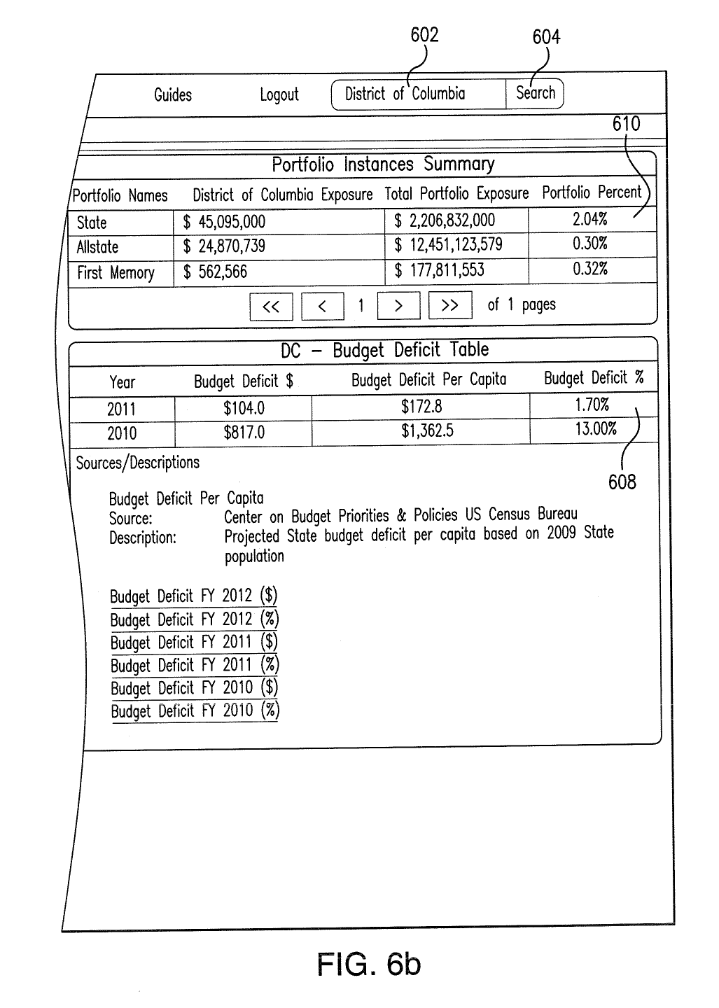

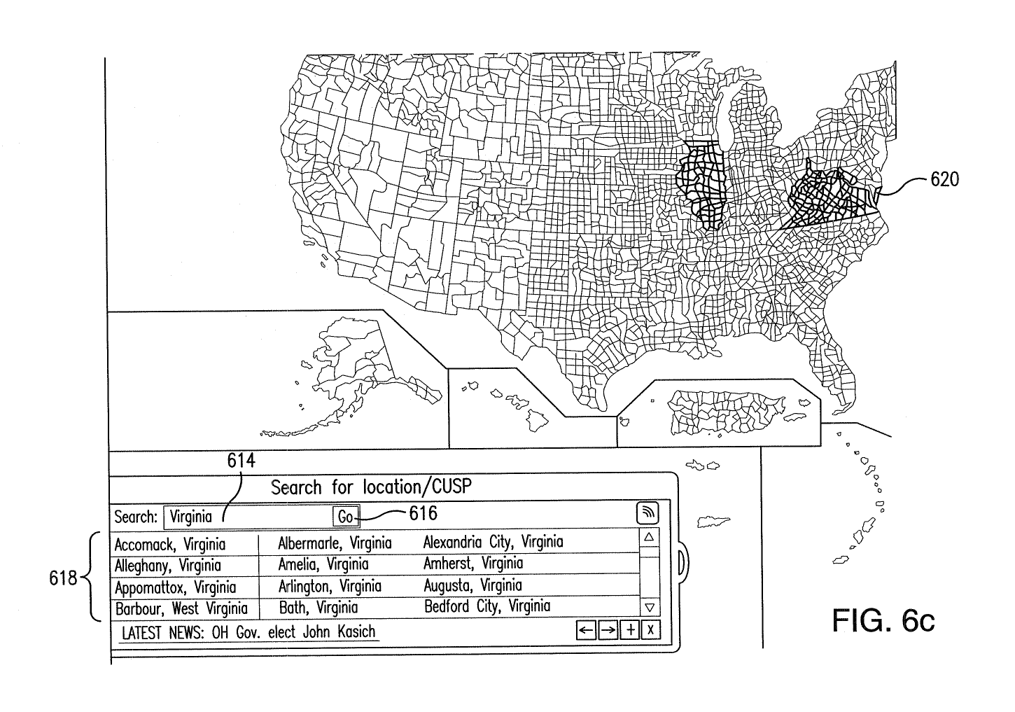

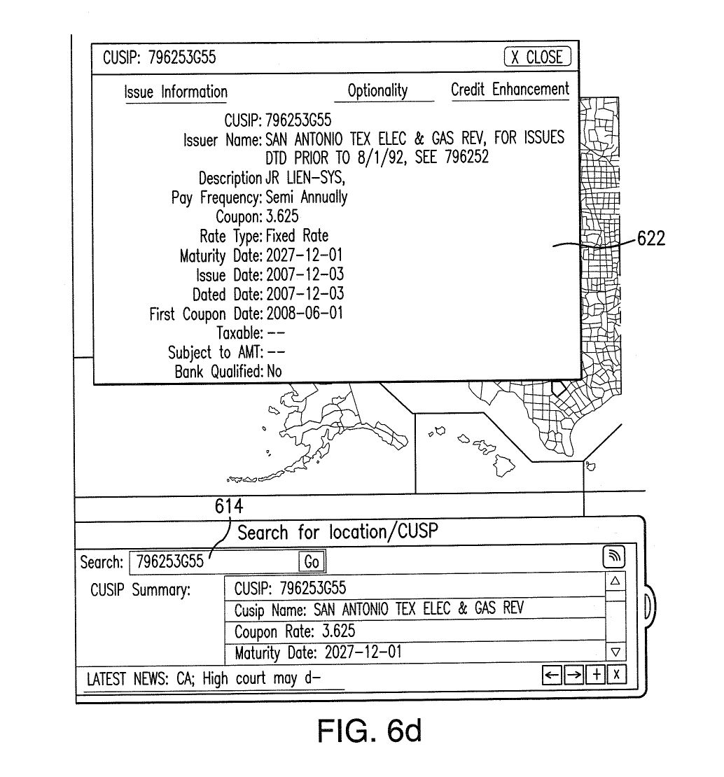

Referencing FIG. 6A, the user can search for any State, county or CUSIP location (602) by entering the filed and selecting “Search” (604). The search tool will return a data menu (606) that shows the data groups and datasets that can be accessed. The user can select any dataset and display the associated graph or table (608). A portfolio instances summary (610) preferably shows all user portfolios that contain exposure to the searched data point. By selecting a portfolio name in the portfolio instances summary (610), specific portfolio positions by location, value and CUSIP are displayed (612). The portfolio positions include sector designation, security or CUSIP price and yield curve.

With reference to FIG. 6A, the user can access data and information for the a predetermined number of the largest cities (e.g., fifty). By selecting any city, the user will be provided an excel worksheet highlighting numerous financial data points and metrics as well as demographic and economic data including, but not limited to, top property tax payers and top employers for the selected city.

With reference now to FIG. 6B, the user can search for any State, county or CUSIP location (614) by entering the searched for item and selecting “Go” (616). As the user enters the searched for item (614), all entries that match the searched for item appear in the results screen (618). After “Go” is selected (616), the searched for location or CUSIP location is highlighted on the map (620). With reference to FIG. 6C, when a CUSIP is searched (614), relevant CUSIP data is summarily displayed (622).

### Information Box, Charts, Tables and Graphs

In another aspect of the present invention, the system and process is configured and operable to enable a user to visualize economic, demographic and financial data using table, charts and graphs for each selected State and/or county. At any time in the interactive session, the custom selected output can be captured and saved for use in the production of financial reports, newsletters and other mediums where visualization of data is desirable. The present invention system and method processes multiple datasets preferably from thirteen data groups: Budget, Commerce, Crime, Disasters, Distress, Education, Health Care, Housing, Income, Legal, Pension, Politics & Government, Population, Taxes and Unemployment/Employment.

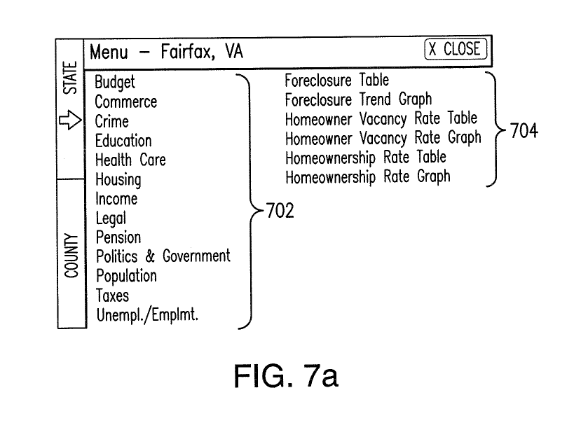

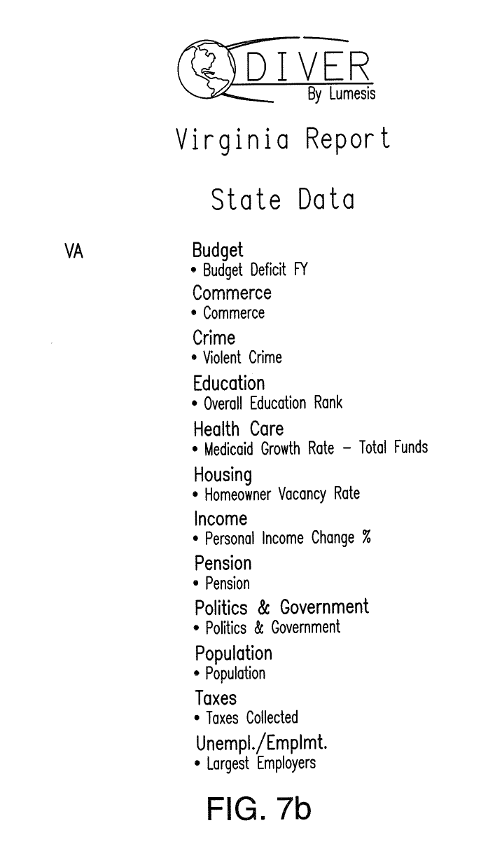

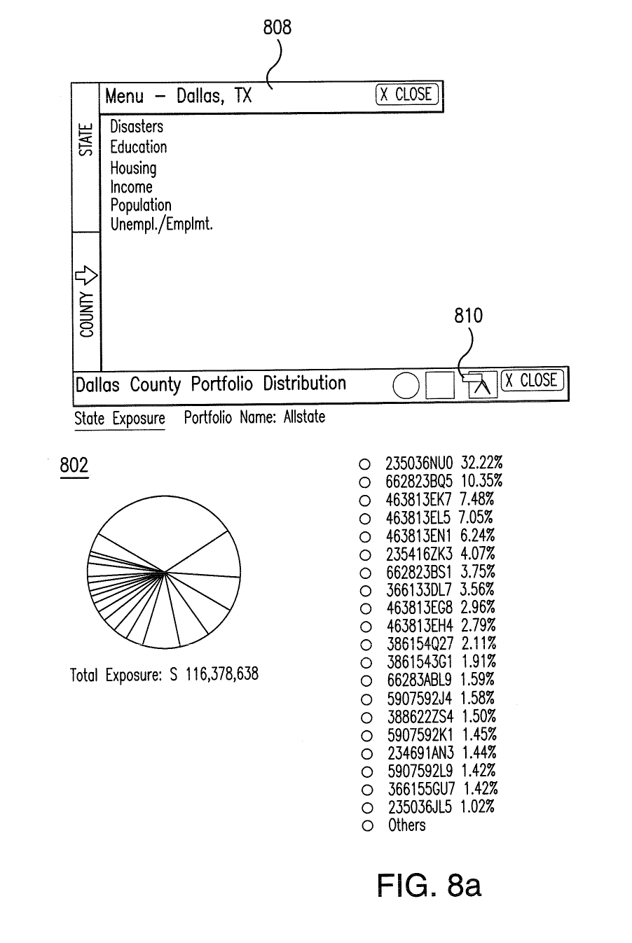

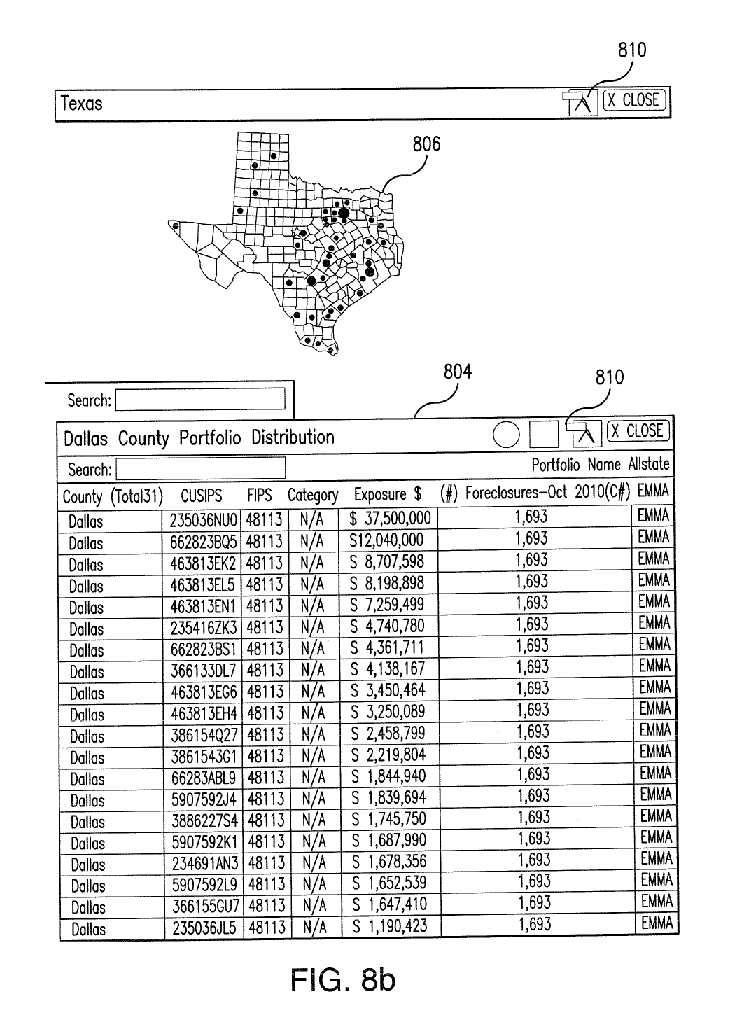

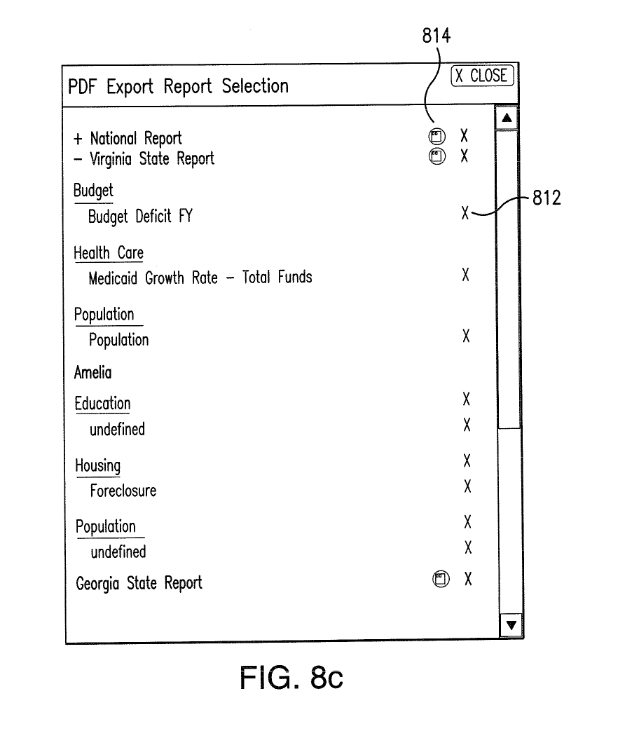

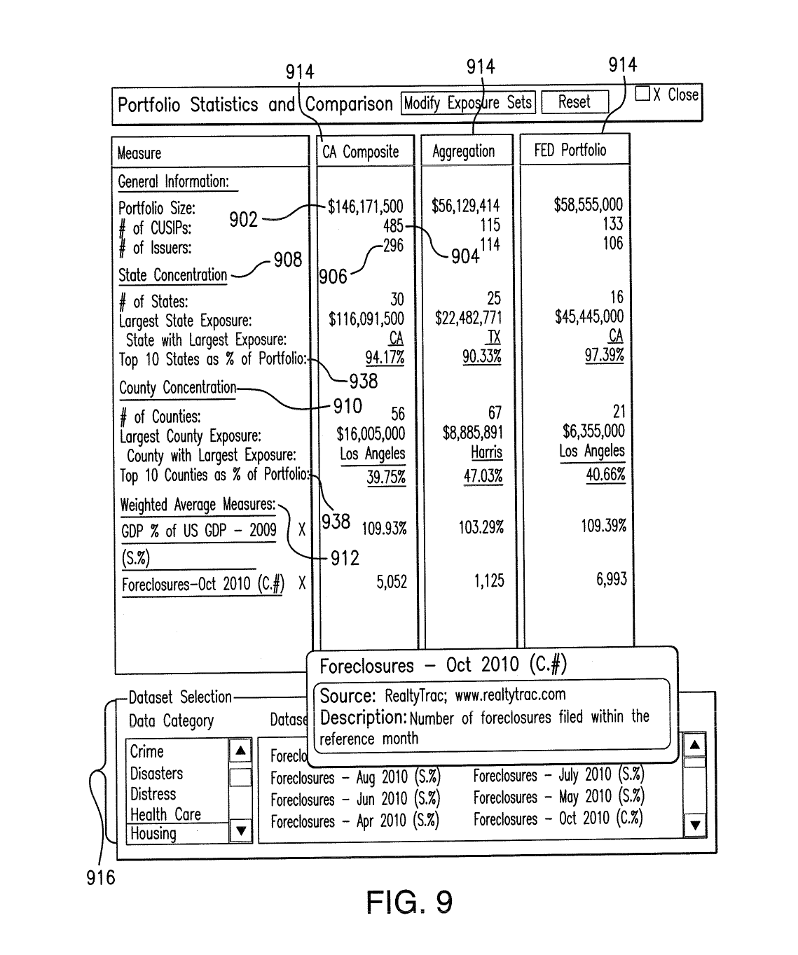

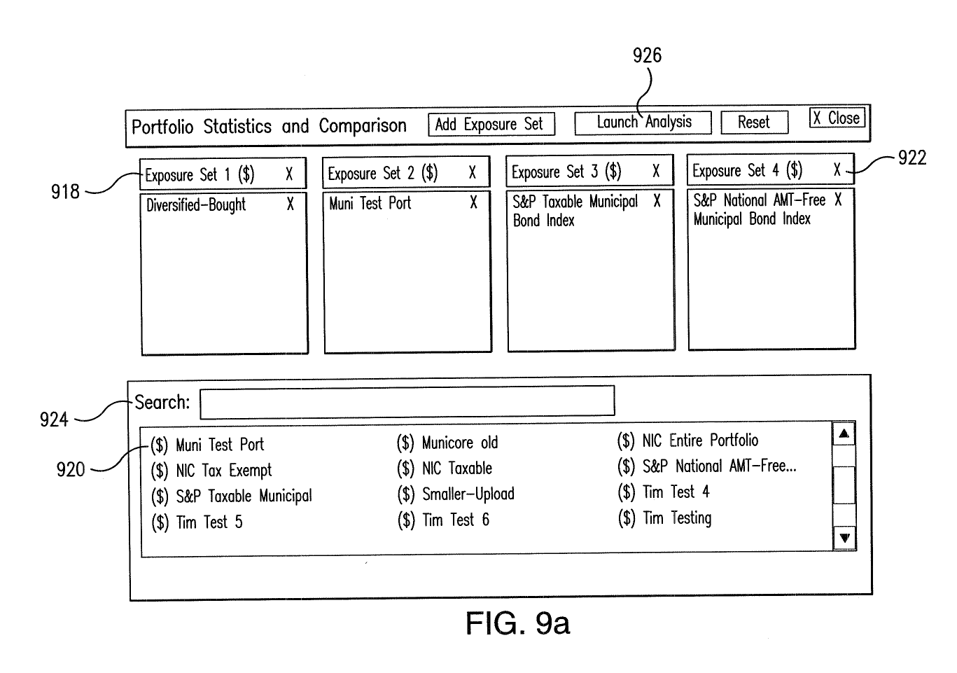

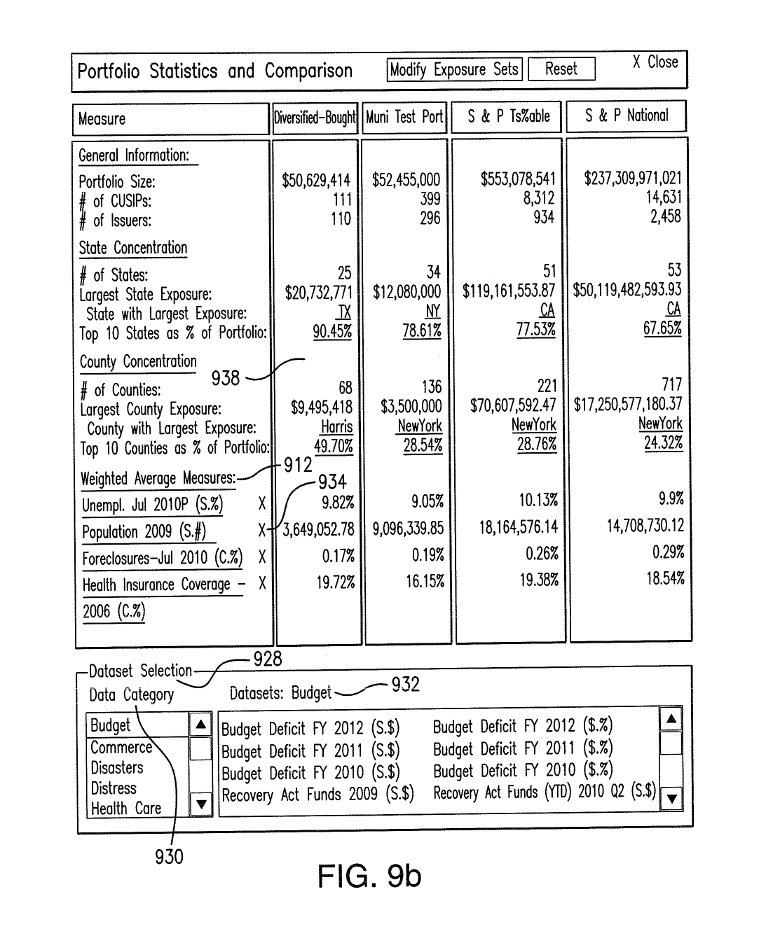

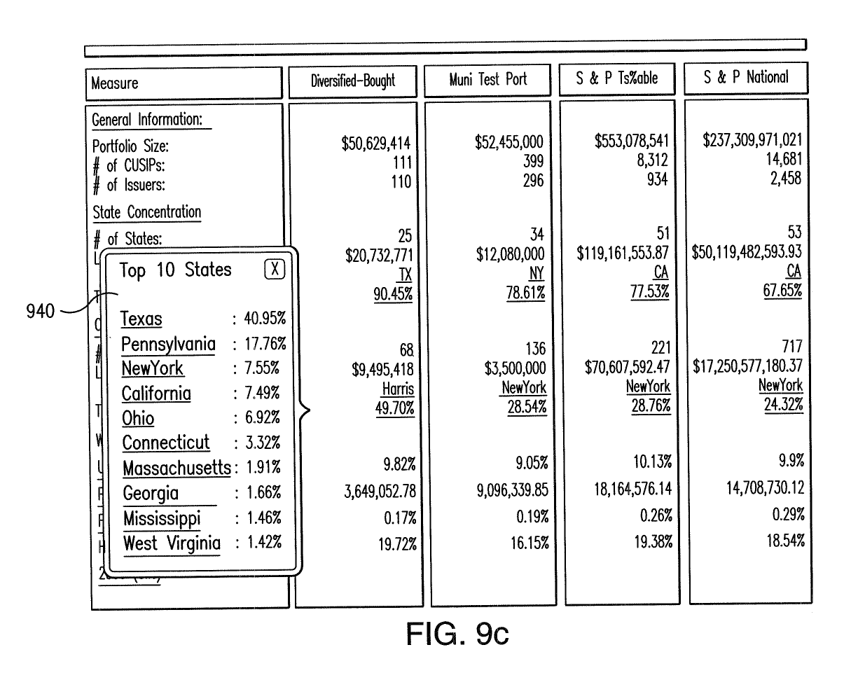

Referencing FIGS. 4A, 4D and 6A, the user can select or search any State, county or portfolio position and display an information box (FIG. 7a), which provides the user the ability to select from data groups and datasets and then graphs, charts and tables. With continued reference to FIG. 7a, the user selects the data categories (702) of interest to reveal dataset dynamic charts, graphs and tables (704) available for view and custom reporting. FIG. 7B is illustrative of a sampling of charts, tables and graphs available for custom view and reporting. With continued reference to FIGS. 4A, 4D, 7A and 7B as reference to types of output, users can create custom reports by selecting the PDF icon (810, FIG. 4A). It is to be appreciated and understood all maps (FIGS. 4A, 4D), Portfolio Statistics and Comparison charts (FIG. 9), portfolio distribution tables/graphs, state maps (FIG. 8A), State/county charts, tables and graphs (FIGS. 7A and 7B) can be selected for custom report creation.

With reference to FIG. 8B, the report creator of system 100 intelligently groups all selected items by relevant State and county. Multiple reports can be created simultaneously and report templates can be saved for later reproduction with new or updated data or portfolios. FIG. 7b illustrates a sample custom report. The user can eliminate a report or selected data items from a report by selecting the “x” (812, FIG. 8B). The user can generate the report by selecting the generate report icon (814) and then print or save the report.

### Portfolio Table, Pie Chart, State Map, Information Box

In another aspect of the present invention, the system 100 and process is configured and operable to enable a user to present portfolio information in a distribution table, pie chart or State map with exposures. With references to FIGS. 4D and 8A, when a portfolio has been mapped with a selected dataset and State/county exposures have been selected, a portfolio distribution chart (802), table (804), state map with exposures and data set (806) and information box (808) are displayed providing the user the ability to access State or county level data as also discussed above with reference to FIGS. 7A and 7B. With continued reference to FIG. 8A, aforesaid data items 802, 804 and 806 are reportable by selecting the PDF icon (810).

With reference to FIG. 8A, the portfolio distribution table (804) provides the CUSIPs in the portfolio, county identification, FIPS/ANSI code, category coded by the user, exposure value and percent, data field mapped and preferably a link to the Municipal Securities Rulemaking Board (MSRB) Electronic Municipal Market Access (EMMA) site to the specific CUSIP.

### Portfolio Statistics % Comparison Tool

In yet another aspect of the present invention, users can compare portfolios and indices for size, concentrations and other credit metrics. With reference to FIG. 9, the Portfolio Statistics and Comparison Tool of the system 100 of the present invention is shown which is configured and operable to display and calculate general portfolio information (size (902), number of CUSIPs (904) and issuers (906)), State and county concentrations (908/910) (e.g., number of States/counties, largest State/county exposure and top 10 States/counties as a percent of the portfolio) and weighted average measures (912) for single and/or aggregate portfolios (exposure sets). The user can compare multiple unique exposure sets (914) all of which can comprise a single portfolio or multiple portfolios allowing the user to compare the aforementioned amongst selected exposure sets. Exposure sets can be modified by the user with a search and/or drag and drop tool. Weighted Average Measure data points can modified by the user (add or delete) from a drag and drop tool bar of all data sets that can be mapped (916).

With reference to FIG. 9, the following further defines the information displayed:
i. General Information:
   i. Portfolio Size (902): Dollar value of the portfolio(s) selected for the Exposure Set.
   ii. Number of CUSIPs (904): Number of unique CUSIPs in the portfolio(s) selected for the Exposure Set.
   iii. Number of Issuers (906): Number of issuers in the portfolio(s) selected for the Exposure Set.
ii. State Concentration (908):
   i. Number of States: Number of States and Territories in the portfolio(s) selected for the Exposure Set.
   ii. Largest State Exposures: Dollar value of the largest State exposure (State and local) in the portfolio(s) selected for the Exposure Set.
   iii. State with Largest Exposure: State with the largest dollar value exposure in the portfolio(s) selected for the Exposure Set.
   iv. Top 10 States as % of Portfolio: 10 States that represent the largest % value of the portfolio(s) selected for the Exposure Set.
iii. County Concentration (910):
   i. Number of Counties: Number of unique counties in the portfolio(s) selected for the Exposure Set.
   ii. Largest County Exposure: Dollar value of the largest county exposure in the portfolio(s) selected for the Exposure Set.
   iii. County with Largest Exposure: County with the largest dollar value exposure in the portfolio(s) selected for the Exposure Set.
   iv. Top 10 Counties as % of Portfolio: 10 counties that represent the largest % value of the portfolio(s) selected for the Exposure Set.
iv. Weighted Average Measures (912): The average for the selected data set(s), weighted by portfolio size for each Exposure Set.
   i. For State level data sets, all State and local exposures within a State are assigned the data value for that State.
   ii. For county level data sets, State level exposures are excluded from the Weighted Average Measure calculation.

With reference now to FIG. 9A, the user can add, delete or aggregate exposure sets (918) from the portfolio list (920) or remove portfolios from this analysis by selecting the “x” next to the exposure set or portfolio name (922). To add or delete portfolios from a given exposure set (918), click on any portfolio (920) and drag it to or from the exposure set (918). The user can use the Search box (924) to search for portfolios to analyze.

With continued reference to 9A, once the user selects the portfolios/exposure sets for analysis, the user preferably selects “Launch Analysis” (926) to initiate the analysis of the data selected and exposure set(s) (918). With reference now to FIG. 9B, the desired Portfolio Statistics and Comparison is generated. The user can then select data set(s) (928) for weighted average measure associated with selected exposure sets (912). Preferably, the user selects a data group name from the “Data Category” (930) and selects the data set (932) to analyze and drag it to the weighted average measures section (912). The user can remove a selected data set by selecting the “X” next to the data set name under the weighted average measures (934).

With reference now to FIGS. 7A and 8A, the user, preferably from the Portfolio Statistics and Comparison tool (FIG. 9), can access portfolio relevant information boxes (FIG. 7A), Pie Charts, Portfolio Distribution information and State Maps indicating exposures (FIG. 8A). With reference to FIG. 9b, the user selects any underscored value (936) in an exposure set and relevant data, charts and maps (FIG. 8a) are displayed.

With reference to FIG. 9, the user can select Top 10 States or Counties as a Percent of Portfolio (938) and generate a list, with percentages of the top 10 holdings by State or county (FIG. 9c, 940). For instance, click on any State or county and a user preferably has access to all depicted data in FIG. 8A.

### Filter Tool

In yet another aspect of the present invention, the user can custom determine parameters based on datasets in the present invention system 100 to identify States and counties of concern or interest and highlight portfolio positions located in filtered States and counties.

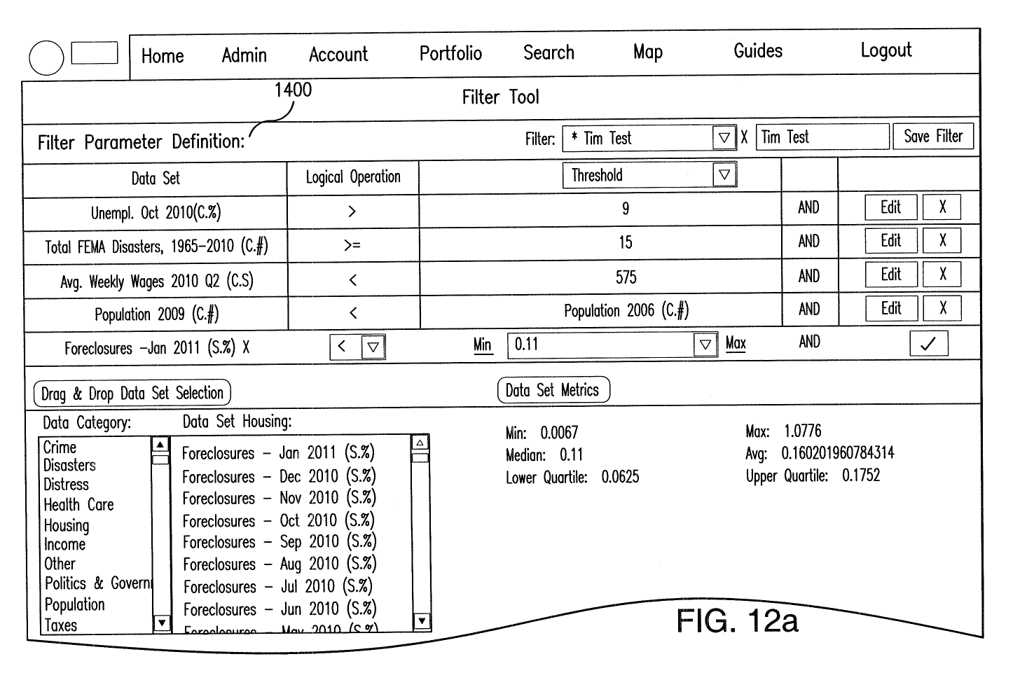

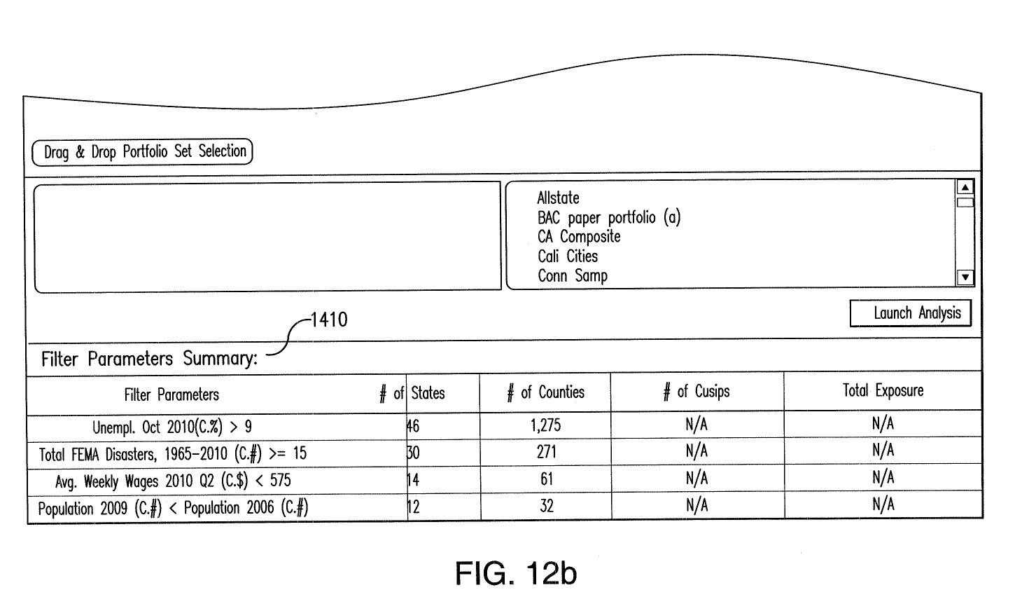

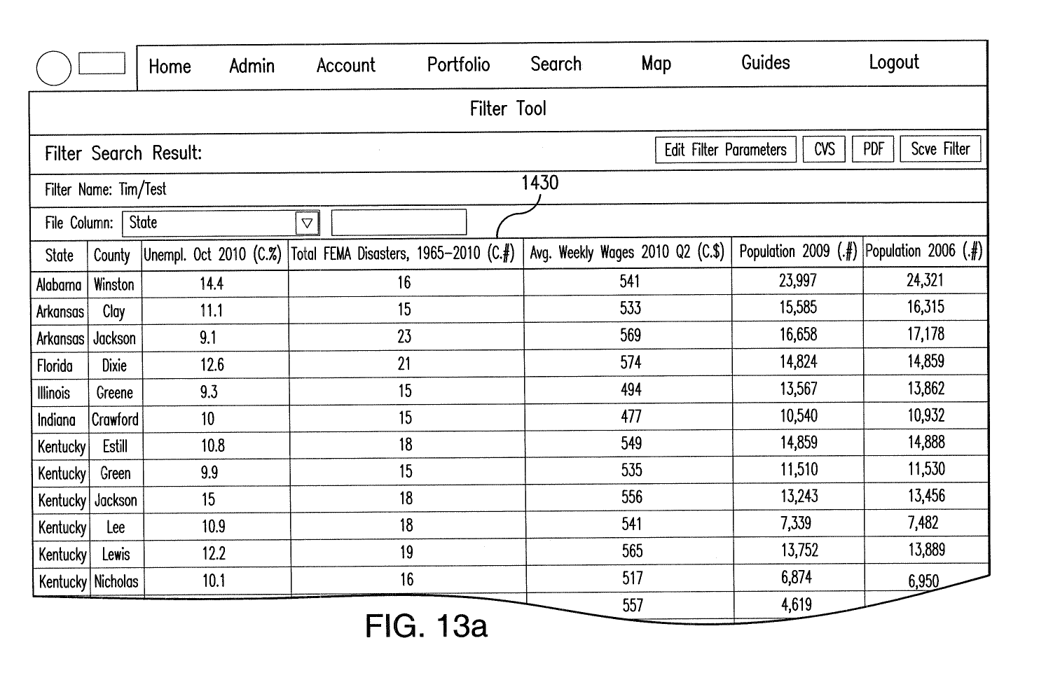

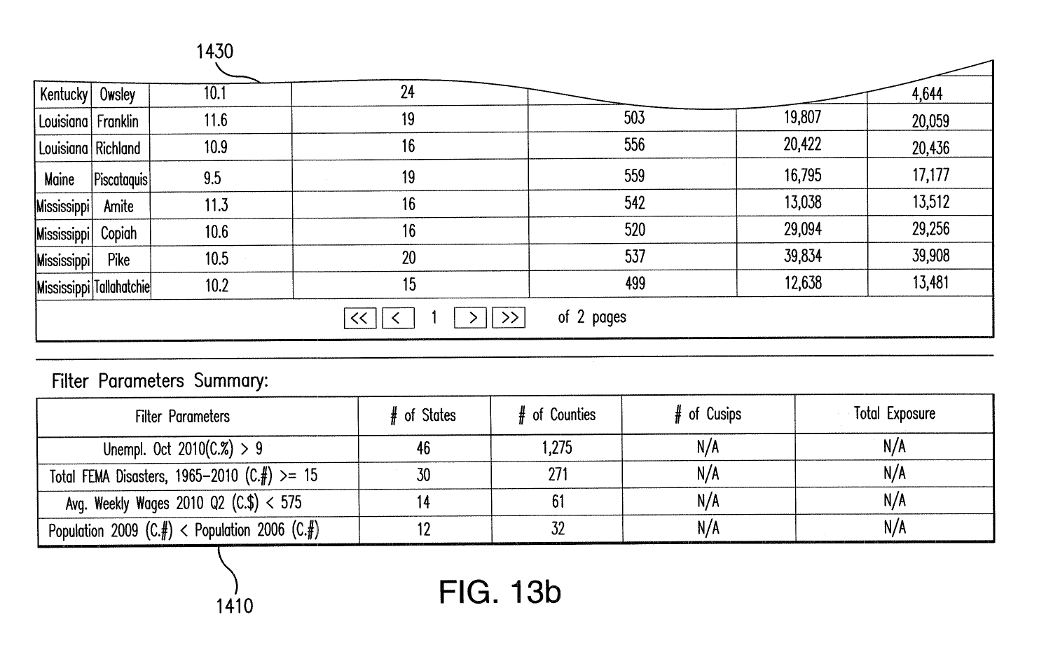

With reference to FIG. 2, The Filter Tool (FT) launches when the FT icon is selected (204). With reference to FIG. 12, when the FT is launched, the Parameter Page opens and displays two sections; the Parameter Definition section (1400) and the Parameter Summary section (1410). The Parameter Definition section (1400) allows the user to define the operable filters that will be applied to geographical areas and portfolios. The Parameter Summary (1410) provides the user real-time summary results of the filter parameters defined (FIG. 13). This allows the user to quickly see whether the parameters being defined are generating too few or too many results.

The user can preferably set and modify the Parameter Definition section, including up to a predetermined amount of different data parameters before generating a detailed report in accordance with the following parameter fields:
Filter Name: User enters in free text (but limited number of characters) to name the filter they are defining.
Data Set: User can drag and drop any Data Set from the Data Set box; when the User selects a particular Data Set and drags it to the Data Set box, the Data Set Metrics box populates.
Data Set Metrics: Provides the User with context and bounds with which to define the parameter. The upper and lower bounds of the data set range are defined by the Min and Max fields. The Avg and Median fields display the mathematical average and median of the data set distribution. The Upper Quartile and Lower Quartile fields display the statistical 25^{th} percentile and 75^{th} percentile of the data set distribution.
Logical Operation: User selects from a drop down menu from the following options: (<,>,=,<=,>=).
Threshold or Data Set: This field allows the User to either enter numbers, or drag and drop Data Sets from the Data Set box. The Data Set selection option. Is preferably used by a User to capture, for example, all areas that have experienced an increase or decrease in a given Data Set.
And/Or: Since the User is able to define up to predetermined amount of Data Parameters, the system 100 allows the User to define how the different parameters relate to each other. For example, the User may want to identify those areas where Initial Jobless Claims are greater than a certain amount OR where Continuing Jobless Claims are greater than a certain amount. From the drop down menu, the User selects either “And”, “Or”, or blank. If only one Data Parameter is defined, then the User may preferably leave this blank.
Edit Buttons: Exist when more than one Data Parameter has been defined, and allows the User to access and therefore amend or delete a particular Data Parameter.
Delete Button: Allows the User to delete the entire Parameter.
Accept (“Checkmark”) Button: When the User has finished defining a new (or amending a pre-existing) Data Parameter, the user preferably clicks the Accept Button, which results in the creation or amendment of the related line in the Parameter Summary section.
Portfolio(s): The User is able to drag and drop an unlimited number of their portfolios into the Portfolio box. This allows the user to include their portfolio positions, in one or more selected portfolios, in the resulting filter tool output if they so desire
Only Areas with Positions: This box preferably does not exist until the User has selected at least one portfolio afterwards the system 100 preferably prompts the user to select either whether they want to view only those States and counties that meet the data parameters defined and represent areas where portfolio positions exist for the portfolios selected.
Launch Analysis Button: When the User has finished defining their Parameters and reviewed the results in the Summary section, they preferably click this button enabling the present invention system 100 to render the detailed results. The results are preferably displayed in the Search Results Page.
Save Filter Button: Enables the User to save their filter so that they can come back and re-generate it at any time. Once this button is clicked, a window will pop-up and prompt the User to enter a Filter name. The name will automatically populate with the Filter Name that the User had entered in the Filter Name field in the Definition section above.

Described below, are the features of the present system 100 found in the Filter Parameters Summary section of FIGS. 14 and 15:
Filter Parameters: Once the first Data Parameter is “Accepted” by the User, the first line of Filter Parameters summary fills with what the User had defined. The system 100 then performs a query and populates the first line of the Filter Summary Results to the right. Each time the User clicks the “Accept” button in the Definition Section, a new line of the Filter Parameters fills in.
Number of States: For the first line, the system displays the number of States (unique 2 digit FIPS/ANSI code) for which Data Parameter 1 holds. For the second line, the system displays the number of States (unique 2 digit FIPS/ANSI code) for which BOTH Data Parameter 1 and Data Parameter 2 hold. As a result, the User is seeing how the population is being filtered down as each successive Data Parameter is applied. Note that the number of States can be determined whether State or County level Data Sets are being used to define the filter. Also note that if one or more Portfolios were selected, and the User only wants the system to display results for areas where they have exposures, then the number of States will be further reduced by eliminating those States where there are no portfolio exposures based on the portfolios selected.
Number of Counties: This displays number of Counties (unique 5 digit FIPS/ANSI code). Note that number of Counties can be returned regardless of whether State or County level Data Sets are selected, If State level Data Sets are selected, then the system 100 will return the total number of counties in all States that meet the filter parameters. Also note that if one or more Portfolios were selected, and the User only wants the system to display results for areas where they have exposures, then the number of Counties will be further reduced by eliminating those Counties where there are no portfolio exposures based on the portfolios selected.
Number of CUSIPs: If no portfolios are selected, then this field will be left blank. If portfolios are selected however, then the number of unique 9 digit CUSIPs that exist in the areas defined by the successive layering of parameters will be displayed. Note that the first County Level Data Set used to define a Filter Parameter will automatically eliminate all State Level exposures. Also note that if only State level Data Sets are used to define the filter parameters, for the States that make it through the filters, all State level positions including exposures located in counties within those States are included in the totals.
Total Exposure: Substantially similar to rules defined above regarding the return of the number of CUSIPs, the system 100 displays the related total amount of exposure for those CUSIPs.

In regards to how the User views the Output from the Defined Filter Parameters (e.g., Search Results Page):
After the User clicks the “Launch Analysis” button on the Parameter Page, the Search Results Page generates.
The Parameter Page will disappear and be replaced by the Search Results Page.

With reference to FIGS. 12 and 13, when the analysis is launched, the Filter Search Results Page opens and displays two sections; the Detailed Search Results section (1430) and the Parameter Summary section (1410). The Filter Search Results Page (FIG. 13) displays for the user, the detailed results generated by the system 100 based on the data parameters defined by the user on the Parameter Page (FIG. 12). The Parameter Summary section (1410) of the Filter Search Results Page (FIG. 13) contains the same data as described above in the section regarding the Filter Parameters Summary (1410) on the Parameter Page (FIG. 12). Hovering over any of the data sets will result in a tool tip that provides the Source, Description and Unit Size data for that data set. Described below, are the features of the present system 100 found in the Filter Parameters Summary section (1410) of FIG. 12:
Edit Filter Parameters Button: When the User clicks on this button, it closes the Search Results Page and re-launches the Parameters Page so that the user can make modifications to the filter parameters.
CSV: Clicking this button allows the User to download the detailed results of the filter search into an Excel Spreadsheet.
PDF: Clicking this button creates a PDF file that displays the entire Filter Search Results as it appears on the screen.
Save Filter: This button works exactly the same as the Save Filter button described above in the Parameter Page section.
Filter Name: This field populates with the Filter Name as defined by the User on the Parameter Page.
Filter Search Results—Results Table: This area will display the detailed results from the filter parameter defined by the User. Different variations of the Results Table will be produced based on the data sets selected by the user and based on whether or not portfolios were selected on the Parameter Page. As exhibited in FIG. F2, a listing of the States, counties, and their respective data set results are displayed. If one or more portfolios are selected, then the total exposure size for each State or county is displayed. The user can click a button to view a detailed listing of the portfolio exposures that met the parameter requirements and are aggregated in the total exposure size displayed. The user can also sort the detailed filter results list by data set result (low to high or high to low), alphabetically by State name or county name, or (if portfolios were included in the filter parameters) by exposure size (low to high or high to low).
Filter Column: From a drop-down menu, the user can select either State, county or any one of the data sets that were used in the definition of the filter parameters. In the field immediately to the right of the drop-down menu, the user can then enter either a State name, county name or any number associated with the selected data set. Upon entry, the application will then display just those results that meet this additional manual filter rule.

In other alternative embodiments of the present invention, the user can also select or omit specific geographic locations, to focus their analysis on. The user can also derive and render new values from the map data using hypothetical scenarios. The present invention system 100 and process may be configured and operable to provide additional granular data such as using zip codes, or other sub-county location designations to be mapped. Still further, the present invention system 100 and process may be configured and operable to allow users to calculate the contribution of each position in the user's portfolio to the weighted average statistics of the user's portfolio, along with ability to sort portfolio by relative contribution of each position to the risk factor providing the ability to weight across par value, book value, market value and duration. In conclusion, what has been described is a software and computer driven application enabling a user to visualize and analyze targeted demographic, economic and financial data using a map of a selected geographic region (e.g., the United States). The present invention system and process provides a user interface which displays objective datasets in a user prescribed format.

As used herein, the term “software” is meant to be synonymous with any code or program that can be in a processor of a host computer, regardless of whether the implementation is in hardware, firmware or as a software computer product available on a disc, a memory storage device, or for download from a remote machine. The embodiments described herein include such software to implement the equations, relationships and algorithms described above. One skilled in the art will appreciate further features and advantages of the invention based on the above-described embodiments. Accordingly, the invention is not to be limited by what has been particularly shown and described, except as indicated by the appended claims. All publications and references cited herein are expressly incorporated herein by reference in their entirety.

Optional embodiments of the present invention may also be said to broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth.

Although illustrated embodiments of the present invention has been described, it should be understood that various changes, substitutions, and alterations can be made by one of ordinary skill in the art without departing from the scope of the present invention.

What is claimed is:

1. A computer-implemented method for producing a graphic image representative of a certain geographic region indicating certain datasets, said method comprising the steps of:
selecting at least one objective dataset correlating to a said certain geographic region;
segmenting said selected at least one objective dataset into a plurality of interval ranges based upon prescribed values;
selecting at least one asset dataset representing financial assets relating to said certain geographic region;
generating said graphic image of said certain geographic region indicating said objective dataset in accordance with said segmentation of said objective dataset into a plurality of interval ranges with said at least one asset dataset superimposed on said objective dataset whereby risk exposure of said asset dataset to said certain geographic regions is graphically illustrated on said generated graphic image.

2. A method as recited in claim 1 wherein said at least one objective dataset corresponds to unemployment data.

3. A method as recited in claim 1 wherein said at least one asset dataset is a financial asset.

4. A method as recited in claim 1 wherein said at least one financial dataset relates to municipal bonds.

5. A method as recited in claim 1 wherein said at least one asset dataset is chosen from the group consisting of hospitals, retail stores and business locations.

6. A method as recited in claim 1 wherein said at least one asset dataset is chosen from the group consisting of agricultural and commodities assets.

7. A method as recited in claim 3 further including the step of additionally displaying on said generated graphic image regions of financial asset liquidity relating to said selected at least one financial dataset operable to enable a user to consummate financial transactions between said regions of financial liquidity and said at least one financial dataset.

8. A computer-implemented method for enabling financial analysis of a user portfolio, comprising the steps of:
providing a user portfolio having at least on financial asset;
selecting at least one objective dataset of interest relative to the user portfolio; and
generating an image of the geographic region indicating the selected objective dataset whereby risk exposure of the user portfolio in correlation with the certain geographic regions is indicated.

9. A computer-implemented method for enabling financial analysis of a user portfolio as recited in claim 8 wherein the at least one financial asset is a municipal bond.

10. A computer-implemented method for enabling financial analysis of a user portfolio as recited in claim 8 further including the step segmenting said selected at least one objective dataset into a plurality of interval ranges based upon prescribed values.

11. A computer-implemented method for enabling financial analysis of a user portfolio as recited in claim 8 wherein the generating an image of the geographic region indicating the selected objective dataset includes segmentation of said objective dataset into a plurality of interval ranges with the at least one financial asset is superimposed on the at least one objective dataset whereby risk exposure of the at least one financial dataset to said certain geographic regions is graphically illustrated on said generated graphic image.

12. A computer-implemented method for enabling financial analysis of a user portfolio as recited in claim 8 further including the step of enabling a user to input a user financial portfolio and/or dataset in a format selected from a group consisting of a spreadsheet or CSV.

13. A computer-implemented method for enabling financial analysis of a user portfolio as recited in claim 12 further including the step of formatting the user input financial portfolio by group categorization, position size and investment categorization.

14. A computer-implemented method for enabling financial analysis of a user portfolio as recited in claim 10 wherein the group categorization is chosen from the group consisting of: CUSIP, FIPS/ANSI code, State FIPS code and zipcode.

15. A computer-implemented method for enabling financial analysis of a user portfolio as recited in claim 13 wherein the investment categorization is chosen from the group consisting of: potential buy, potential sell, bought, sold, upgrade, downgrade, watch, illiquid, taxable and tax-exempt.

16. A computer-implemented method for enabling financial analysis of a user portfolio as recited in claim 12 further including the step calculating and displaying weighted average measures and concentrations for a user portfolio.

17. A computer-implemented method for enabling financial analysis of a user portfolio as recited in claim 13 wherein the user portfolio is an aggregate of user portfolios.

18. A computer-implemented method for enabling financial analysis of a user portfolio as recited in claim 12 further including the step displaying exposure for a user portfolio in accordance with a prescribed percentage of predetermined user financial assets.

19. A computer-implemented method for enabling financial analysis of a user portfolio as recited in claim 12 wherein the generating an image of the geographic region step includes displaying a financial exposure amount for the user portfolio with corresponding CUSIPs for the user portfolio.

20. A computer-implemented method for enabling financial analysis of a user portfolio as recited in claim 19 wherein each of the displayed CUSIPs is user searchable indicating relevant CUSIP data.

21. A computer-implemented method for enabling financial analysis of a user portfolio as recited in claim 12 further including the step of calculating and indicating an aggregate exposure value for at least one user portfolio.

22. A computer-implemented method for enabling financial analysis of a user portfolio as recited in claim 8 further including the step of mapping CUSIPs to FIPs regarding a said financial asset.

23. A computer-implemented method for enabling financial analysis of a user portfolio as recited in claim 8 further including the step of enabling a user to prescribe parameters relating to a said financial asset to identify geographic regions of interest dependent upon said prescribed parameters.
